(19) United States
(12) Patent Application Publication
(10) Pub. No.: US 2025/0215196 A1
(43) Pub. Date: Jul. 3, 2025

(54) METHOD AND SYSTEM FOR HANDLING OF GRANULES

(71) Applicant: CERTAINTEED LLC, Malvern, PA (US)

(72) Inventors: Erin Lynn CAMPONESCHI BROTHERSON, Avondale, PA (US); Kevin Galloway, Saint Louis, MO (US); Julie Tinklenberg, Downingtown, PA (US); Brent Smith, Pottstown, PA (US); Jun Yan, Malvern, PA (US); Patrick T. Heppert, Belle Plaine, MN (US)

(21) Appl. No.: 19/003,355

(22) Filed: Dec. 27, 2024

Related U.S. Application Data
(60) Provisional application No. 63/615,540, filed on Dec. 28, 2023.
(60) Provisional application No. 63/615,520, filed on Dec. 28, 2023.
(60) Provisional application No. 63/615,531, filed on Dec. 28, 2023.

(51) Int. Cl. C08K 11/00; C08L 95/00; E04D 1/00; E04D 1/26; E04D 1/28

(52) U.S. Cl. CPC C08K 11/005; C08L 95/00; E04D 1/26; E04D 1/28; C08K 2201/005; C08L 2555/52; E04D 2001/005

(57) ABSTRACT

A building product having a body including a covered region including granules, at least 18 wt % of the granules include reclaimed granules having an average residual asphalt of at least 0.1 wt % for a total weight of the reclaimed granules.

### CROSS-REFERENCE TO CORRESPONDING APPLICATIONS

This application claims priority under 35 U.S.C. § 119(e) to U.S. Provisional Patent Application No. 63/615,540, entitled “METHOD AND SYSTEM FOR HANDLING OF GRANULES,” by Erin Lynn CAMPONESCHI BROTHERSON et al., filed Dec. 28, 2023, and claims priority under 35 U.S.C. § 119(e) to U.S. Provisional Patent Application No. 63/615,520, entitled “METHOD AND SYSTEM FOR HANDLING OF GRANULES,” by Erin Lynn CAMPONESCHI BROTHERSON et al., filed Dec. 28, 2023, and claims priority under 35 U.S.C. § 119(e) to U.S. Provisional Patent Application No. 63/615,531, entitled “METHOD AND SYSTEM FOR HANDLING OF GRANULES,” by Erin Lynn CAMPONESCHI BROTHERSON et al., filed Dec. 28, 2023, all of which are assigned to the current assignee hereof and are incorporated herein by reference in their entireties.

### BACKGROUND

### Field of the Disclosure

The following is directed to a method and system for handling granules, and in particular, granules including reclaimed granules.

### Description of the Related Art

Building products come in a variety of forms and the market for new building products is expanding. Certain building products, including roofing products, are made of a base material and a bituminous material. Conventionally, the bituminous material can include asphalt, filler, and other additives depending upon the intended use. A variety of fillers have been used including limestone, talc, fly ash, coal fines, or other relatively inert materials. Depending on the applications, building products may also include one or more layers of granulated material for improving the performance and/or lifetime.

There is a need in the industry for an effective and economical method for recycling building products, including residential roofing products. It is estimated that over 12 million tons of roofing waste are created annually. Moreover, there are additional expenses incurred in hauling and disposing of the waste. The materials present in various building products may take generations to decompose.

### BRIEF DESCRIPTION OF THE DRAWINGS

The present disclosure may be better understood, and its numerous features and advantages made apparent to those skilled in the art by referencing the accompanying drawings.

FIG. 1 includes a method for using granules, including reclaimed granules, according to an embodiment.

FIG. 2A includes a cross-sectional illustration of a container according to an embodiment.

FIGS. 2B-2F include cross-sectional illustrations of containers according to embodiments.

FIG. 2G includes an illustration of an opening of a container overlying a conveyor according to an embodiment.

FIG. 3 includes an illustration of a process for evaluating and separating granules according to an embodiment.

FIG. 4 includes an illustration of a system for evaluating and separating granules according to an embodiment.

FIG. 5A includes a top-down illustration of a distribution system.

FIG. 5B includes a side-view illustration of the system of FIG. 5A.

FIG. 5C includes an isometric view illustration of the system of FIG. 5A.

FIG. 6A includes an illustration of a portion of a distribution device according to an embodiment.

FIG. 6B includes an illustration of a portion of a distribution device according to an embodiment.

FIG. 6C includes an illustration of a portion of a distribution device according to an embodiment.

FIG. 6D includes an illustration of a portion of a distribution device according to an embodiment.

FIG. 6E includes an isometric view illustration of a distribution device according to an embodiment.

FIG. 7 includes a schematic of a system for distribution of granules to form a building product according to an embodiment.

FIGS. 8A-8C include illustrations of a roofing shingle according to an embodiment.

FIGS. 9A and 9B include cross-sectional illustrations of roofing membranes according to an embodiment.

### DETAILED DESCRIPTION

The following description in combination with the figures is provided to assist in understanding the teachings provided herein. The following disclosure will focus on specific implementations and embodiments of the teachings. This focus is provided to assist in describing the teachings and should not be interpreted as a limitation on the scope or applicability of the teachings. However, other teachings can certainly be used in this application.

As used herein, the term “reclaimed granule” refers to a granule that has been part of a commercial product, including for example, but not limited to, a roofing product. Reclaimed granules are part of a post-consumer waste stream. Recycled granules are distinct from reclaimed granules. Recycled granules refer to granules that are recycled during a manufacturing process and are not part of a post-consumer waste stream.

The present application is directed to systems and methods for use with granules, including reclaimed granules. Some prior art references have suggested that reclaimed granules can be re-used to make new building products. In fact, some prior art references have suggested that reclaimed granules can be treated and cleaned to assist with their re-use to make new building products. However, despite these suggestions in the literature, the industry has struggled to develop a system for re-using reclaimed granules. Applicants have identified challenges associated with the use of reclaimed granules and have developed certain methods and systems according to the embodiments herein.

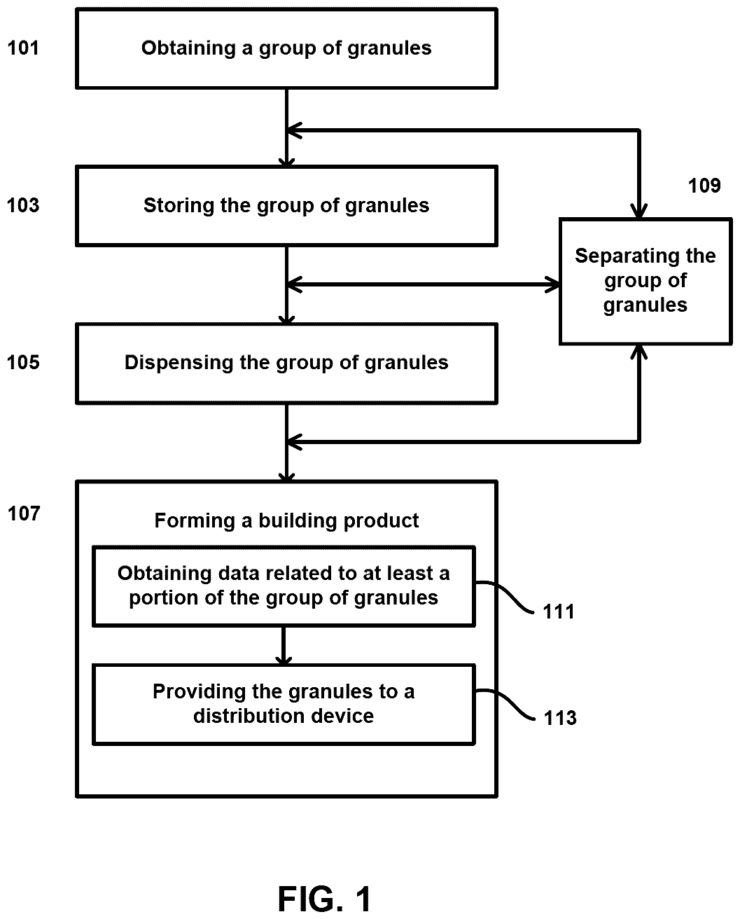

FIG. 1 includes a method for using granules, including reclaimed granules. As provided at step 101, the process can begin by obtaining a group of granules. According to an embodiment, the group of granules can include reclaimed granules. The reclaimed granules can come from a variety of post-consumer waste streams and thus have a greater variation of certain granule characteristics than virgin granules used to form the first generation of building product. The variation in granule characteristics creates challenges in the handling of reclaimed granules and deployment of the reclaimed granules into building products. In fact, it has been found that even small contents of reclaimed granules within a group of granules can have an unexpected impact on the storage, handling, and deployment of the group of granules.

According to one embodiment, the group of granules may include at least 1 wt % reclaimed granules for a total weight of the granules. In another embodiment, the content of reclaimed granules within a group of granules can be greater, such as at least 5 wt % or at least 10 wt % or at least 15 wt %, or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 98 wt % for a total weight of the group of granules. In one particular embodiment, all of the granules in the group of granules can be reclaimed granules. Still, in a non-limiting embodiment, the group of granules may include not greater than 99 wt % reclaimed granules for a total weight of the group of granules, such as not greater than 90 wt % or not greater than 80 wt % or not greater than 70 wt % or not greater than 60 wt % or not greater than 50 wt % or not greater than 40 wt % or not greater than 30 wt % or not greater than 20 wt %. It will be appreciated that the group of granules can include a weight percent of reclaimed granules within a range including any of the minimum and maximum values noted above, including for example, but not limited to, within a range of at least 1 wt % and not greater than 99 wt % or within a range of at least 20 wt % and not greater than 99 wt % or within a range of at least 40 wt % and not greater than 99 wt %.

In one embodiment, a group of granules may include a plurality of granules. In another embodiment, the group of granules can include at least 1 kg of granules, such as at least 10 kg or at least 100 kg or at least 1,000 kg or at least 10,000 kg or at least 100,000 kg. In one non-limiting embodiment, the group of granules may be an amount of granules suitable for commercial scale manufacturing of a building product.

Through empirical studies, it has been found that even small amounts of certain materials that are part of the reclaimed granules can have a notable impact on the storage, handling and deployment of reclaimed granules. While some efforts have been made to develop processes for cleaning reclaimed granules, in practice, such processes do not completely clean the reclaimed granules.

In one embodiment, the reclaimed granules, which may be obtained after a cleaning process, may still include some minimum content of residual asphalt. For example, according to one embodiment, the reclaimed granules can include at least 0.1 wt % residual asphalt on an exterior surface of the granules for a total weight of the reclaimed granules. In other embodiments, the content of residual asphalt may be greater, such as at least 0.3 wt % or at least 0.5 wt % or at least 1 wt % or at least 2 wt % or at least 3 wt % or at least 4 wt % or at least 5 wt % or at least 6 wt % or at least 7 wt % or at least 8 wt % or at least 9 wt % or at least 10 wt % or at least or at least 15 wt %, or at least 20 wt % or at least 25 wt % or at least 30 wt % or at least 35 wt % or at least 40 wt % or at least 45 wt % or at least 50 wt % for a total weight of the reclaimed granules. Still, in another non-limiting embodiment, the content of the residual asphalt on the reclaimed granules may be not greater than 90 wt % residual asphalt on an exterior surface of the granules for a total weight of the reclaimed granules, such as not greater than 80 wt % or not greater than 70 wt % or not greater than 60 wt % or not greater than 50 wt % or not greater than 40 wt % or not greater than 30 wt % or not greater than 20 wt % or not greater than 15 wt % or not greater than 10 wt % or not greater than 8 wt % or not greater than 6 wt %. It will be appreciated that the content of residual asphalt on the reclaimed granules can be within a range including any of the minimum and maximum percentages noted above, including for example, but not limited to, within a range of at least 0.1 wt % and not greater than 90 wt % or within a range including at least 0.1 wt % and not greater than 50 wt % or within a range including at least 0.3 wt % and not greater than 10 wt %. The content of residual asphalt on the reclaimed granules is determined by taking a group of granules weighing not less than 50 grams and recording this as the starting weight (Ws). The group of granules are subjecting to a heating process of 540° C. for a duration of 2 hours to volatilize the residual asphalt. After heating and volatilization, the group of granules are weighed again to record the end weight (We). The weight of the residual asphalt is the difference in weight between the starting weight and the end weight (i.e., weight of residual asphalt (Wre)=Ws−We). The weight percent content of residual asphalt of the reclaimed granules is calculated as (Wre/Ws)×100.

The residual asphalt can be an asphalt-containing material that may include one or more fillers that may be used in the formation of the building product. For example, in the context of some roofing products, the asphalt-containing material can be a filled asphalt coating that includes certain fillers, such as limestone. The residual asphalt may include asphalt from the building product that has aged and become adhered or attached to the exterior surface of the granule. The residual asphalt may be oxidized and/or hardened due to extended exposure to environmental elements (e.g., sun).

In one embodiment, the process for obtaining the group of granules can include one or more optional processes, including for example, treating of the group of granules or at least a portion of the group of granules prior to obtaining. In one embodiment, treating may include a cleaning process. In another non-limiting embodiment, an optional process may include coating the granules or a portion of the granules. The coating may include a material that facilitates storing, handling, and/or deployment of the granules.

After obtaining the granules, the process may continue at step 103, which includes storing the granules. Certain manufacturing processes may store the group of granules for a duration until they are ready for deployment onto a building product.

According to one embodiment, storing the group of granules can include storing the group of granules in a container, wherein the container may have one or more features of 1) an environment control system, 2) a mechanism for moving at least a portion of the reclaimed granules, and/or 3) an adhesion control system. Without wishing to be tied to a particular idea, it has been noted through Applicants' studies that even small amounts of reclaimed granules with small amounts of residual asphalt content can limit the ability to effectively store and/or dispense the group of granules. The group of granules within the container can have any one or more features of the group of granules as provided in any of the embodiments herein.

According to one embodiment, the container for storing the group of granules can have an environment control system configured to control the environment within the container, which may improve the storing, handling and deployment of the group of granules. In some instances, excess temperatures have been noted to have a negative impact on the group of granules, even when the group of granules has small amounts of reclaimed granules. It will be appreciated that the container may use one or more environment control systems as provided in any of the embodiments herein. In one instance, the environment control system may be configured to control one or more properties of the environment within the container, including for example, but not limited to, temperature, humidity, air flow, gaseous composition, pressure of one or more gaseous species, total gas pressure, and the like.

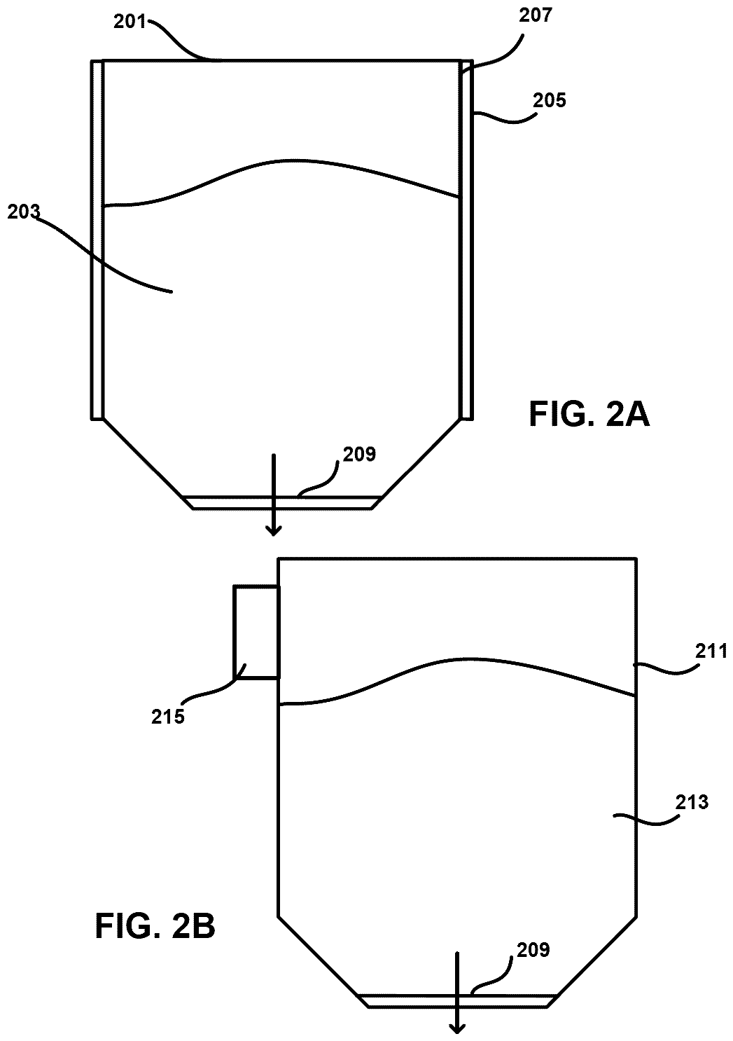

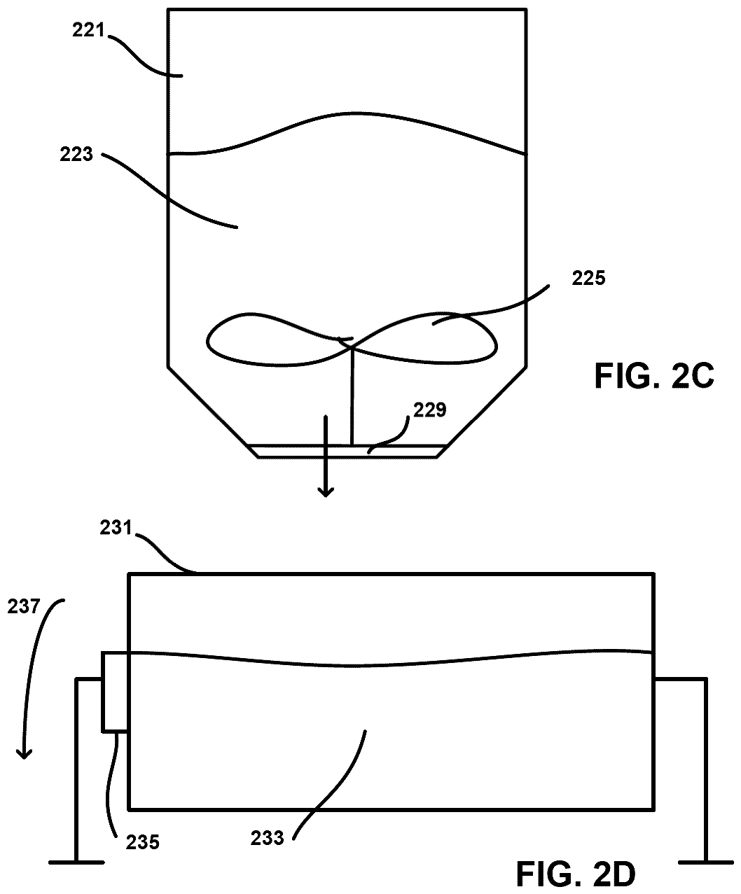

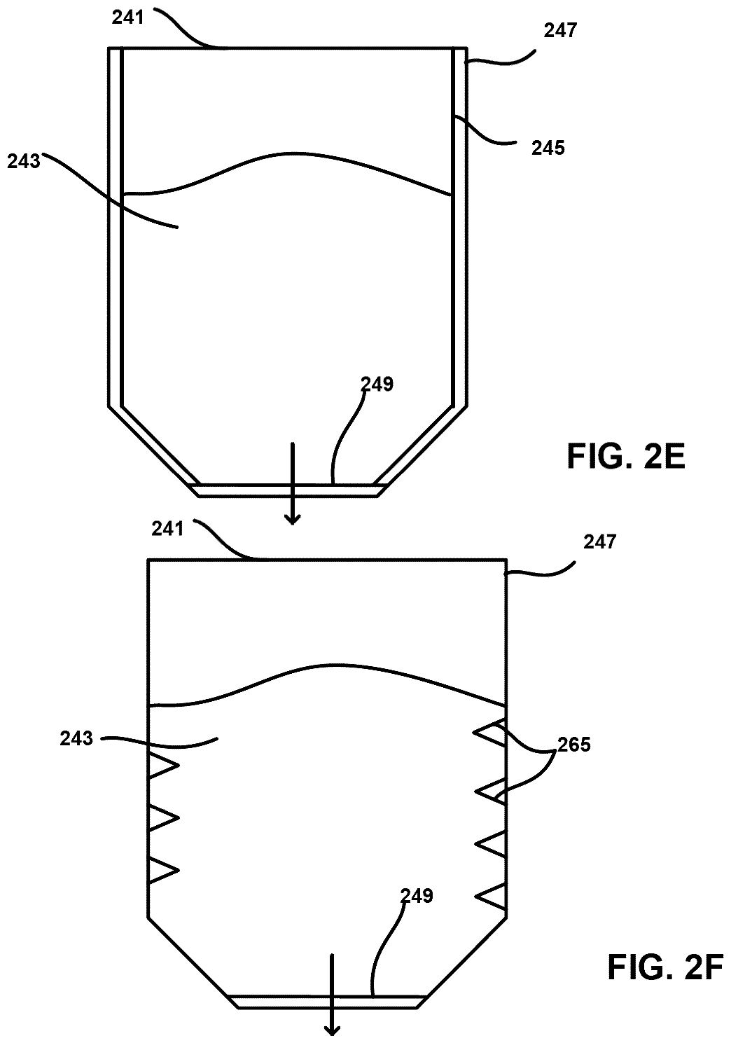

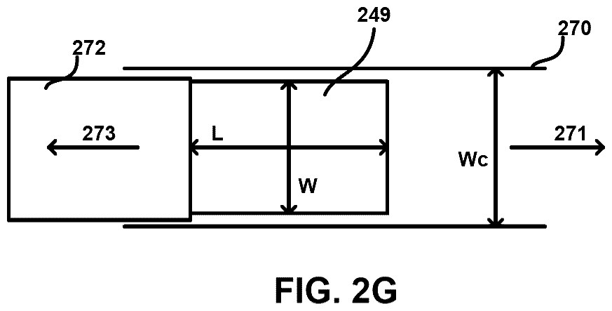

FIG. 2A includes a cross-sectional image of a container according to an embodiment. According to one embodiment, the container 201 may include a group of granules 203 contained within an interior volume of the container 201, and further include a port 209 configured for dispensing of the granules 203 from the container 201. As will be appreciated, the container 201 may further include one or more ports configured to facilitate filling of the container 201 with the group of granules 203.

In one embodiment, the container 201 may include an environment control system including a coating 205 on a surface of the container 201. The coating may facilitate control of the internal temperature within the interior of the container 201, which may facilitate improved storing, handling and/or deployment of the group of granules 203. In a particular embodiment, the coating 205 may overlie at least a portion of an exterior surface 207 of the container 201. In such instances, the coating 205 may define the outermost or exterior surface of the assembly of the container 201 and coating 205. In one instance, the coating 205 may overlie a particular portion of the container 201, such as at least at least 10% of a total surface area of the exterior surface 207 of the container 201. Still, in another non-limiting embodiment, the coating 205 may overlie at least 20% or at least 30% or at least 35% or at least 40% or at least 45% or at least 50% or at least 55% or at least 60% or at least 65% or at least 70% or at least 75% or at least 80% or at least 85% or at least 90% or at least 95% or at least 98% of the total surface area of the exterior surface 207 of the container 201. In one embodiment, the coating 205 may overlie essentially the entire exterior surface 207 of the container 201.

In another embodiment, the coating 205 may be coupled directly to the exterior surface 207 of the container 201. For example, the coating 205 may be adhered or attached directly to the exterior surface 207 of the container. In another embodiment, the coating may overlie but not necessarily be bonded to or directly attached to the exterior surface 207 of the container 201. In yet another embodiment, the coating 205 may be indirectly coupled to the exterior surface 207, such that one or more layers of additional material can be disposed between the coating 205 and the exterior surface 207 of the container 201.

For one non-limiting embodiment, the coating 205 may include at least one material selected from the group of an organic material, an inorganic material, a multilayered composite, a naturally occurring material, a film, a fabric, a paint, a particulate material, or any combinations thereof. Still, in a more particular embodiment, the coating 205 may include a film, a paint, a fabric or any combination thereof.

In yet another instance, the coating 205 may include a material configured to reflect certain types of electromagnetic radiation, which may facilitate improved storing, handling and/or deployment of the group of granules 203. For example, in one embodiment, the coating 205 may include a material having a solar reflectance of at least 0.1 or at least 0.15 or at least 0.2 or at least 0.25 or at least 0.3 or at least 0.35 or at least 0.4 or at least 0.45 or at least 0.5 or at least 0.55 or at least 0.6 or at least 0.65 or at least 0.7 or at least 0.75 or at least 0.8 or at least 0.85 or at least 0.9 or at least 0.95 or at least 0.98 according to ASTM C1549-16. Still, in another embodiment, the solar reflectance of a material of the coating 205 may be not greater than 1.0 or not greater than 0.99. It will be appreciated that the solar reflectance of a material of the coating 205 can be within a range including any of the minimum and maximum values noted above.

For another embodiment, the coating 205, in its entirety, may be configured to reflect certain types of electromagnetic radiation, which may facilitate improved storing, handling and/or deployment of the group of granules 203. For example, in one embodiment, the coating 205 may having a solar reflectance of at least 0.1 or at least 0.15 or at least 0.2 or at least 0.25 or at least 0.3 or at least 0.35 or at least 0.4 or at least 0.45 or at least 0.5 or at least 0.55 or at least 0.6 or at least 0.65 or at least 0.7 or at least 0.75 or at least 0.8 or at least 0.85 or at least 0.9 or at least 0.95 or at least 0.98 according to ASTM C1549-16. Still, in another embodiment, the solar reflectance of the coating 205 may be not greater than 1.0 or not greater than 0.99. It will be appreciated that the solar reflectance of the coating 205 can be within a range including any of the minimum and maximum values noted above.

In yet another aspect, the environment control system may be configured to maintain a certain environment within the container. According to one embodiment, the environment control system may include one or more devices configured to measure and adapt the environment within the container. In one aspect, the one or more devices can include devices configured to regulate and/or maintain one or more environmental characteristics within a container. The environmental characteristic may include, but is not limited to, temperature, humidity, air flow, gaseous composition, and the like.

FIG. 2B includes a cross-sectional illustration of a container according to an embodiment. As illustrated, the container 211 may include a group of granules 213 contained within an interior volume of the container 211. The container may also include a port 219 configured for dispensing of the granules 213 from the container 211. As provided in the illustrated embodiment, the container 211 may further include one or more ports configured to facilitate filling of the container 211 with the group of granules 213. Moreover, in the embodiment of FIG. 2B, the container 211 may include an environment control system 215 coupled to the container 201 and configured to measure, maintain and/or regulate one or more environmental characteristics within the interior volume of the container 211.

According to one embodiment, the environment control system may be configured to maintain an environmental characteristic at or near one or more threshold values. In a particular embodiment, the one or more threshold values may be based at least in part upon a rating of the granules, wherein in the rating can be associated with 1) a content of asphalt in the granules, 2) a content of reclaimed granules in the group of granules, or a combination of 1) and 2). It will be appreciated that the rating associated with the content of asphalt and the granules and or content of reclaimed granules in the group of granules maybe created electronically through automated processes, or alternatively, maybe based upon operator input.

In certain instances, the environment control system may be configured to maintain a temperature below a threshold value based upon a rating of the granules associated with a content of asphalt in the granules, a content of reclaimed granules in the group of granules, or a combination thereof. In a particular embodiment the environment control system can include a heating and/or cooling system. For example, the environment control system may be configured to maintain a temperature within the interior of the container of not greater than 65° C. or not greater than 60° C. or not greater than 55° C. or not or not greater than 50° C. or not greater than 45° C. or not greater than 40° C. or not greater than 38° C. or not greater than 36° C. or not greater than 34° C. or not greater than 32° C. or not greater than 30° C. or not greater than 28° C.

Still, in another embodiment, the environment control system may be configured to maintain a temperature above a threshold value based upon a rating of the granules associated with a content of asphalt in the granules, a content of reclaimed granules in the group of granules, or a combination thereof. For example, the environment control system may be configured to maintain a temperature within the interior of the container of at least −10° C. or at least −5° C. or at least 0° C. or at least 5° C. or at least 10° C. or at least 15° C. or at least 20° C. In an embodiment, the environment control system may be configured to maintain a temperature within a range between any of the minimum and maximum values noted above.

In yet another embodiment, the environment control system may be configured to maintain a particular humidity and/or relative humidity within the container relative to one or more threshold values so as to prevent condensation, and especially to prevent condensation when the temperature changes. In one embodiment, the environment control system can be configured to maintain a relative humidity within the container at no greater than 90% of the saturation concentration at that thermodynamic state, such as no greater than 85% of the saturation concentration at that thermodynamic state, or no greater than 80% of the saturation concentration at that thermodynamic state, or no greater than 50% of the saturation concentration at that thermodynamic state, or no greater than 30% of the saturation concentration at that thermodynamic state. In one embodiment, the environment control system can be configured to maintain a relative humidity within the container at no less than 5% of the saturation concentration at that thermodynamic state, such as no less than 10% of the saturation concentration at that thermodynamic state. In one embodiment, the environment control system can be configured to maintain an absolute humidity within the container at no greater than 8% water vapor. In a particular embodiment, the one or more threshold values can be based at least in part upon a rating of the granules within the container, wherein the rating of the granules can be associated with a content of asphalt in the granules, a content of reclaimed granules in the group of granules, or a combination thereof.

In an embodiment, the environment control system may be configured to maintain a certain air pressure and/or composition of the gases within the interior of the container relative to one or more threshold values. The threshold values can be based at least in part upon a rating of the granules within the interior of the container and wherein the rating of the granules can be associated with a content of asphalt in the granules, a content of reclaimed granules in the group of granules, or a combination thereof. In one embodiment, the environment control system can be configured to maintain an air pressure within the container at no greater than 100 psi, such as no greater than 50 psi, or no greater than 40 psi. In one embodiment, the environment control system can be configured to maintain a composition of gases within the container to include more than 0% and no more than 98% nitrogen, such as more than 0% and no more than 90% nitrogen, and more than 0% and no more than 50% nitrogen. It will be appreciated that the rating associated with the content of asphalt and the granules and or content of reclaimed granules in the group of granules maybe created electronically through automated processes, or alternatively, maybe based upon operator input.

In another aspect, the environment control system may include one or more devices configured to control the flow of air through the container. In one embodiment, the environment control system can be configured to maintain air flow within the container at a speed of no greater than 4000 ft./min., such as no greater than 3000 ft./min. and no less than 0 ft./min. In one embodiment, the environment control system can be configured to maintain air flow within the container at a speed of no greater than 500 cubic feet per minute (cfm), such as no greater than 400 cfm, or such as no greater than 100 cfm. In one embodiment, the environment control system can be configured to maintain air flow within the container at a speed of no less than 0 cfm, such as no less than 5 cfm, or no less than 10 cfm. In a particular embodiment, the environment control system can be configured to control the flow of air through the container based on one or more threshold values, wherein the one or more threshold values can be based at least in part upon a rating of the granules within the interior of the container and wherein the rating of the granules can be associated with a content of asphalt in the granules, a content of reclaimed granules in the group of granules, or a combination thereof.

According to another aspect, the container may include a mechanism for moving at least a portion of the group of granules within the container relative to each other, which may facilitate improved storing, handling and/or deployment of the granules. In certain embodiments, the container may be moved to facilitate movement of the granules contained therein. In other embodiments, one or more mechanisms may include a device within the container configured to facilitate relative movement of the granules to each other without necessarily moving the entire container. In one embodiment, the granules can be moved once/every 10 minutes, such as once/every 30 minutes, or once/hour, or once/day, or once/every two days, or once/month. It will be appreciated that one or more mechanisms may be employed to facilitate relative movement of the granules to each other.

FIG. 2C includes a cross-sectional illustration of a container according to an embodiment. The container 221 may include granules 223 contained therein and a port two 229 configured for dispensing the granules 223 from the container 221. The container 221 may further include one or more ports configured to facilitate filling of the container 211 with a group of granules 213.

In the embodiment of FIG. 2C, the container 221 may include a mechanism 225 configure to facilitate movement of at least a portion of the group of granules relative to each other within the container 221. As will be appreciated, the container 221 may include a mechanism 225 configured to facilitate movement of at least a portion of the group of granules relative to each other within the container 221. Moreover, in one particular instance, the mechanism 225 may be configured to maintain relative motion of at least a portion of the reclaimed granules in the group of granules 223. According to one embodiment, the mechanism 225 can be configured to move, such as rotate, which may facilitate relative movement of the granules 223 within the container 221.

FIG. 2D includes a cross-sectional illustration of a container according to an embodiment. As illustrated, the container 231 can include granules 233 contained in the interior volume. According to the embodiment of FIG. 2D, the container 231 may include a mechanism 235 configure to facilitate rotation of the container 231. Rotation of the container 231, such as in the direction 237, may facilitate movement of the granules within the container. While not illustrated, it will be appreciated that the container 231 may include one or more ports for filling and emptying the group of granules from the container.

In still another aspect, a container including a group of granules including reclaimed granules may include an adhesion control system configured to limit the adhesion of the granules to the container and/or to each other, which may facilitate improved storage, handling, and/or deployment of the group of granules. The adhesion control system may be configured to reduce tangential cohesive forces and/or tangential resistive forces between the granules and the container. FIG. 2E includes a cross-sectional illustration of a container according to an embodiment. As illustrated, the container 241 may include granules 243 contained within the interior volume of the container 241. The container 241 may further include a port 249 configured to facilitate dispensing of the granules contained therein.

In one embodiment, the container 241 may include an adhesion control system 245. In one instance, the adhesion control system 245 may include a component configured to limit the adhesion of the granules to each other and or the interior surface of the container 241. In a particular embodiment, the adhesion control system 245 may include a coating overlying at least a portion of the interior surface 247 of the container 241. In one particular embodiment, the coating may overlie a certain percentage of a total surface area of the interior surface 247 of the container 241 to limit the adhesion of the granules 243 to the interior of the container 241 and to other granules. In one instance, the coating may overlie at least 10% of a total surface area of the interior surface of the container 241, such as at least 20% or at least 30% or at least 35% or at least 40% or at least 45% or at least 50% or at least 55% or at least 60% or at least 65% or at least 70% or at least 75% or at least 80% or at least 85% or at least 90% or at least 95% or at least 98% of the total surface area of the interior surface of the container. According to a particular embodiment, the entire interior surface 247 of the container 241 can have the coating.

The coating 245 may include a particular material that may limit the adhesion of the granules to the container 241 and to each other. In one particular instance, the material may include an organic material, an inorganic material, a multilayered composite, a naturally occurring material, a film, a fabric, a paint, a particulate material, or any combinations thereof. Still, in one embodiment, the coating 245 comprises at least one of a film, a paint, a fabric or any combination thereof. According to one particular embodiment, the coating 245 may include a metal or metal alloy, including for example, but not limited to, an iron-containing material, such as steel.

In one aspect, the coating 245 may be attached to at least a portion of the interior surface 247 of the container 241. For example, the coating 245 can be mechanically and/or chemically attached to at least a portion of the interior surface 247. In one embodiment, the coating 245 can be an insert placed within the interior of the container 241. In a more particular embodiment, the container 241 may be made of a ceramic material (e.g., cement) or metal and the coating 245 may be an insert or liner made of a metal or metal alloy.

For at least one aspect, the coating 245 may include a material having a particular surface energy. In one instance, the coating 245 may include a material having a surface energy of not greater than 45 m/Jm² or not greater than 42 m/Jm² or not greater than 40 m/Jm² or not greater than 38 m/Jm² or not greater than 35 m/Jm² or not greater than 32 m/Jm² or not greater than 30 m/Jm² or not greater than 28 m/Jm². The surface energy is measured according to ASTM D5946 Standard Test Method for Corona-Treated Polymer Films Using Water Contact Angle Measurements.

And in another aspect, the coating 245, in its entirety, may have a particular surface energy. For example, in one embodiment, the coating may have a surface energy of 45 m/Jm² or not greater than 42 m/Jm² or not greater than 40 m/Jm² or not greater than 38 m/Jm² or not greater than 35 m/Jm² or not greater than 32 m/Jm² or not greater than 30 m/Jm² or not greater than 28 m/Jm². The surface energy is measured according to ASTM D5946 Standard Test Method for Corona-Treated Polymer Films Using Water Contact Angle Measurements. According to one embodiment, the adhesion control system may include a container 241 having an interior surface 247 or coating 245 with an interior surface having a particular surface roughness that reduces the likelihood of the group of granules adhering to the container 241. According to one embodiment, the interior surface of the coating 245 or container 241 may have an average surface roughness (Ra) of not greater than 50 mm or not greater than 40 mm or not greater than 30 mm or not greater than 20 mm or not greater than 10 mm or not greater than 5 mm or not greater than 1 mm or not greater than 0.8 mm or not greater than 0.5 mm or not greater than 0.2 mm or not greater than 0.1 mm or not greater than 0.08 mm or not greater than 0.05 mm or not greater than 0.02 mm. In one non-limiting embodiment, the average surface roughness (Ra) can be at least 0.1 microns or at least 1 micron or at least 2 microns or at least 5 microns or at least 10 microns or at least 50 microns or at least 100 microns or at least 200 microns or at least 500 microns. It will be appreciated that the average surface roughness can be within a range including any of the minimum and maximum values noted above.

As described herein, the adhesion control system may be configured to reduce tangential cohesive forces and/or tangential resistive forces between the granules and the container. Tangential cohesive and resistive forces are determined utilizing the continuum modeling in accordance with methods outlines in University of Utah Bulletins 108, 116, and 123 and as implemented by Jenike and Johanson. In one embodiment, the outlet characteristic size to avoid rat hole formation for the recycled granules may be between 3.2 ft. and 6.8 ft over a temperature range of 70° F. and 150° F. FIG. 2F includes a cross-sectional illustration of a container according to an embodiment. As illustrated, the container 241 may include granules 243 contained within the interior volume of the container 241. The container 241 may further include a port 249 configured to facilitate dispensing of the granules contained therein. In one aspect, the adhesion control system may include one or more internal structures 265 on an interior surface 247 of the container 241 that may be configured to limit adhesion between the granules 243 and the container 241. The one or more internal structures may also improve flow of the granules 243 during dispensing the granules 243 from the container 241.

Referring again to FIG. 1, after storing the group of granules, the process may include dispensing the group of granules at step 105. In one aspect, the group of granules may be dispensed from the container. The group of granules may then be subject to one or more optional processes, including for example, but not limited to, treatment (e.g., coating), sorting, agitation, mixing with other materials, and the like.

In an embodiment, suitable storage of the group of granules may limit agglomeration of the granules in the container and facilitate suitable dispensing. In one embodiment, dispensing the group of granules from the container may be conducted such that the dispensed granules have limited or no agglomeration.

FIG. 2G includes an illustration of an opening of a container overlying a conveyor according to an embodiment. As provided herein, the container 241 may include a port 249 configured to facilitate the dispensing of the granules from the container 241 onto a conveyor 270 configured to translate (e.g., in direction 271) under the port 249 and convey the dispensed granules to another stage of the operation. In the context of the embodiment of FIG. 2G, a container may have a port 249 having a non-circular or non-elliptical two dimensional opening as viewed in the plane of the length (L) and width (W) of the port 249. According to another embodiment, the port 2499 can have a polygonal two-dimensional shape, including for example, but not limited to, a square two-dimensional shape, a rectangular two-dimensional shape, and the like. In one particular embodiment, the port 249 can have a two-dimensional shape in the form of a rectangle with a length (L) that is greater than the width (W) of the port 249. Moreover, the width (W) of the port 249 may be equal to or less than the width (Wc) of the conveyor 270 onto which the granules 243 are dispensed from the container 241. It is preferred that the port 249 have a polygonal shape, such that the width of the port 249 is controlled relative to the width (Wc) of the conveyor 270 to avoid excessive granule loss upon dispensing, while also controlling the length (L) of the port 249 to facilitate suitable dispensing of the granules 243. According to empirical studies, the storage of granules including reclaimed granules, even small amounts of reclaimed granules with minimal amounts of residual asphalt can lead to unexpected difficulties in dispensing of the granules from conventional containers. Accordingly, a port 249 having suitable dimensions of length (L) and width (W) have been found to improve the dispensing of the granules, even when their storage leads to undesirable issues, such as agglomeration and the like. In one embodiment, an aspect ratio of length to width can be 10:1, such as 3:1, or such as 2:1. In one embodiment, the length (L) can be no greater than 15 ft., such as 12 ft., or 10 ft. In one embodiment, the bin wall angle can be between 0 degrees and 90 degrees from vertical. Bin wall angle is the angle of the walls of the container that hold the granules.

In one non-limiting embodiment, the container may include a sliding element 272 configured to be moved (e.g., in direction 273) relative to the opening defining the port 249 and configured to control the length (L) of the opening of the port 249 during dispensing that may facilitate improved dispensing of the granules from the container onto the conveyor 270.

Referring again to FIG. 1, after storing the group of granules, the process may include dispensing the group of granules at step 105. In one aspect, the group of granules may be dispensed from the container. The group of granules may then be subject to one or more optional processes, including for example, but not limited to, treatment (e.g., coating), sorting, mixing with other materials, and the like.

Referring again to FIG. 1, the process may further include separating the group of granules at step 109. According to an embodiment, the process of separating the group of granules may be conducted at one or more various optional points within the process. For example, in one embodiment, the process of separating may be done after obtaining a group of granules, but before storing the group of granules. In an alternative embodiment, separating may be conducted after storing the group of granules, but before dispensing the group of granules. Still, in another embodiment, the process of separating may be conducted after dispensing the group of granules, but before forming the building product. The process of separating the group of granules may be conducted multiple times during the process, including for example, at a first time before storing the group of granules and again after dispensing the group of granules. Furthermore, in another aspect, the process of separating may also include separating at least a portion of a group of granules into collections of granules, wherein a first collection may be inserted into a first place in the process and a second collection may be inserted into a second, different place in the process.

In still another embodiment, the process for separating may be used in place of one or more processes provided. For example, in one non-limiting embodiment, the group of granules may undergo separating at step 109 after obtaining the group of granules but before storing the group of granules. In such a process, the group of granules that have been separated may be sent directly to the process for forming a building product without necessarily storing or dispensing the group of granules. It will be appreciated that other process flows may be utilized based upon the preferred sequence of steps and timing of separating of the group of granules relative to the other steps of the process as provided herein.

According to one aspect, the process of separating the group of granules may include separating the group of granules into a plurality of collections including at least a first collection of granules and a second collection of granules. In one particular instance, the first collection may have a granule characteristic that is different than at least one granule characteristic of the granules in the second collection. Suitable non-limiting examples of granule characteristics may include, but is not limited to, color, density, average size, shape, composition, asphalt content, asphalt age, particle size distribution, or any combination thereof.

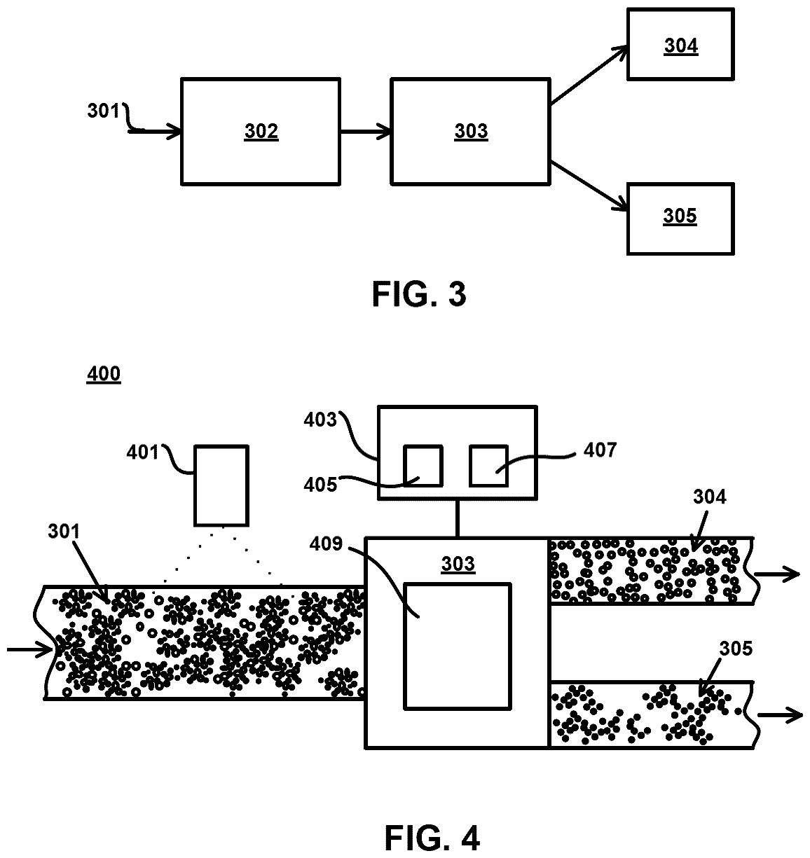

FIG. 3 includes an illustration of a process of separating a group of granules according to an embodiment. As illustrated, the process may include providing a group of granules 301 that may be subject to an evaluation region 302, and thereafter a separation region 303, which may include separation of at least a portion of the group of granules into different collections, including for example, but not limited to, a first collection 304 and a second collection 305.

According to one embodiment, the group of granules 301 may be conveyed through the evaluation region 302. In the evaluation region 302, at least a portion of the group of granules 301 may be evaluated for one or more granule characteristics. In a more particular embodiment, evaluating at least one granule characteristic of at least a portion of the group of granules can include assigning at least one characteristic value to a portion of the granules. In certain instances, the characteristic value may be used to assist with the separation process. In a more particular embodiment, evaluating may include assigning a characteristic value to one or more individual granules of the portion of granules. As will be appreciated, the characteristic value of the one or more individual granules may be used to assist with separation of the granules into one or more collections.

In another aspect, after the granules are evaluated in the evaluation region 302 they may be subject to a separation process in the separation region 303. According to one embodiment, separating may include separating the group of granules based upon at least one characteristic value. That is, for example, granules having at least one different characteristic value can be separated into different collections. More particularly, in at least one embodiment, the group of granules may be separated into the first collection 304 and the second collection 305, wherein the granules of the first collection 304 are assigned at least one different characteristic value as compared to the granules in the second collection 305. It will be appreciated that the group of granules 301 may be separated into as many different collections as preferred to facilitate suitable sorting of the granules according to one or more granule characteristics, which may facilitate improved formation of a building product.

According to one aspect, the portion of granules that are evaluated for a granule characteristic may include at least 10% of the total number of granules in the group of granules. Still, in other embodiments, the portion may be at least 20%, such as at least 30% or at least 40% or at least 50% or at least 60% or at least 70% or at least 80% or at least 90% or at least 95%. In one particular instance, all of the granules of the group of granules are evaluated for at least one granule characteristic.

According to one aspect, the portion of granules that are assigned a characteristic value may include at least 10% of the total number of granules in the group of granules. Still, in other embodiments, the portion of granules assigned a characteristic value may be at least 20%, such as at least 30% or at least 40% or at least 50% or at least 60% or at least 70% or at least 80% or at least 90% or at least 95%. In one particular instance, all of the granules of the group of granules are assigned a characteristic value.

Any of the processes of the embodiments herein may be conducted as a continuous process. For example, in one embodiment, the group of granules 301 may be conveyed while undergoing evaluation and/or separation. In one particular embodiment, the process of evaluating and conveying may be conducted simultaneously. For example, the group of granules 301 may be conveyed through the evaluation region 302, which may include one or more evaluation stages and one or more evaluation devices, wherein at least a portion of the granules of the group of granules 301 are evaluated for one or more granule characteristics. For example, in a particular embodiment, the evaluation region 302 may include devices capable of sensing one or more granule characteristics as the granules are being conveyed. In certain instances, the rate of conveyance of the group of granules 301 may be controlled to facilitate characterization of a suitable portion of the granules with one or more granule characteristics. In yet another aspect, the distribution of the group of granules on the conveyor system may be controlled to facilitate characterization of a suitable portion of the granules with one or more granule characteristics. It will be appreciated that one or more aspects of the conveyance of the group of granules 301, including for example the rate of conveyance, the distribution of the granules on the conveyor, and the like, can be controlled at least in part by the devices conducting the evaluation.

According to another aspect, the group of granules 301 may be conveyed while undergoing separation. In one particular embodiment, the process of separating and conveying may be conducted simultaneously. For example, the group of granules 301 may be conveyed through the separation region 303, which may include one or more separation stages and/or one or more separation devices, wherein at least a portion of the granules of the group of granules 301 may be separated into collections based on one or more granule characteristics. For example, in a particular embodiment, the separation region 303 may include devices capable of separating one or more granules into distinct collections. In certain instances, the rate of conveyance of the group of granules 301 may be controlled to facilitate separation of the granules into collections based on one or more granule characteristics. In yet another aspect, the distribution of the group of granules on the conveyor system may be controlled to facilitate separation of a suitable portion of the granules with one or more granule characteristics. It will be appreciated that one or more aspects of the conveyance of the group of granules 301, including for example the rate of conveyance, the distribution of the granules on the conveyor, and the like, can be controlled at least in part by the devices conducting the separation process. In one embodiment, the group of granules 301 may be separated into one or more single layer streams of granules to facilitate suitable evaluation and separation.

FIG. 4 includes an illustration of a system for evaluating and separating granules according to an embodiment. According to one embodiment, the system 400 can include one or more sensors 401 that may be configured to detect at least one granule characteristic of at least a portion of a group of granules 301.

According to one embodiment, the one or more sensors 401 configured to detect one or more granule characteristics of the group of granules 301, may be an optical sensor. In one embodiment, the optical sensor may be configured to operate over a range of wavelengths within the visible spectrum. In still another embodiment, the optical sensor operates using wavelengths including and/or outside of the visible spectrum. For example, one optical sensor may use infrared or UV wavelengths for evaluating at least one granule characteristic of the group of granules 301.

In another embodiment, the evaluation region 302 may include more than one sensor, wherein each sensor may be configured to detect a particular granule characteristic. In still another embodiment, a single sensor may be used to detect a plurality of granule characteristics.

In another aspect, the system 400 may further include a controller 403, which may be communicatively coupled to the one or more sensors 401. In one embodiment, the system may include a memory 405 and a processor 407. As will be appreciated, the memory 405 and/or processor 407 may be part of the controller 403 or may be separate devices that are in communication with each other through a wired or wireless connection. According to another aspect, the one or more sensors 401 can be communicatively coupled to the processor 403, memory 405 and processor 407 through a wired or wireless connection. In a particular embodiment, the controller 403 may be configured to execute instructions from the processor 407 based on at least one granular characteristic detected by the one or more sensors 401. Such instructions may be used to control one or more devices associated with the separation process in the separation region 303.

In one aspect, the one or more sensors 401 may be configured to evaluate at least a portion of the granules of the group of granules 301. In an embodiment, the one or more sensors 401 can be configured to capture information associated with at least a portion of the granules of the group of granules 301. In one embodiment, the information can include granular characteristics such as size and/or shape and/or color. In another embodiment, the information is captured and stored as digital information. In one aspect, the digital information can be stored in a memory as non-transient, machine-readable data, which may be analyzed by one or more programs. In one embodiment, analysis of the digital information may be conducted by a program stored on the processor 407. In still another embodiment, the processor 407 may be configured to analyze the digital information using a program and assign a characteristic value to individual granules or a plurality of granules based on the information in the digital information. In yet another aspect, the characteristic value may be stored as data in the memory 405. In certain instances, one or more characteristic values may be used to develop one or more executable instructions by the processor 407, wherein the one or more executable instructions may be used by the controller 403 to facilitate a separation process.

According to one embodiment, a characteristic value may be a value associated with a granule characteristic. In at least one embodiment, a granule characteristic may be associated with more than one characteristic value. For example, a granule characteristic such as color, may be associated with a plurality of characteristic values (e.g., red, blue, yellow, etc.) based on the detected color of one or more granules within the group of granules 301. In one aspect, at least a portion of the group of granules can be separated based upon their characteristic values. For example, the system 400 may facilitate separation of the group of granules 301 based upon color, wherein granules having a first characteristic value (e.g., blue) are separated into a first collection and granules having a second and different characteristic value as compared to the first characteristic value (e.g., black) are separated into a second collection.

According to one embodiment, the separation process may include a process for assigning a first characteristic value for granules with less than a threshold amount of detected asphalt on the exterior of the granules. In one embodiment, a threshold amount of asphalt is no greater than 25% by weight, such as no greater than 15% by weight, or no greater than 10% by weight. The amount of asphalt on the exterior of the granules is determined by the Federal Highway Administration's (FHWA) method described in “Improving Accuracy of Asphalt Content Determination by Ignition Test” by Rodezno and Brown, 2017. In another aspect of the embodiment, a second characteristic value may be assigned to granules of the group of granules 301 having an amount of detected asphalt above the threshold amount. The granules having the first characteristic value may be separated into a first collection and the granules having the second characteristic value may be separated into a second collection. In such an embodiment, the granules of the first and second collections may be conveyed to preferred points in the process. For example, the granules of the first collection may be blended with other granules and used to create a building product. In another aspect, the granules of the second collection may be subject to further treatments, including for example, but not limited to cleaning, coating, further evaluation, further separation and the like.

In another aspect, the controller 403 may be communicatively coupled to one or more devices 409 configured to conduct separation of the group of granules 301 into the collections 304 and 305. The controller 403 may be in communication with the one or more devices 409 via a wired or wireless connection. According to one non-limiting embodiment, the one or more devices 409 may include a robotic device, one or more sieves, one or more micromanipulators, controlled nozzles (e.g., air jets), and the like. According to one embodiment, the device may include a micromanipulator capable of utilizing inputs from one or more controllers to facilitate separation of the group of granules 301. In a more particular embodiment, the process may include one or more micromanipulators capable of evaluating and separating at least a portion of the group of granules 301. In such instances, the group of granules 301 may be first separated into two or more streams of granules, wherein each of the streams may be sent to one or more micromanipulators capable of conducting the evaluation and separation of the granules from the respective streams of granules.

In another aspect, the distribution of the group of granules 301 may be controlled and/or separated into one or more useable streams of granules such that a device, such as one or more controlled air jets may be configured to conduct a separation operation. For example, the group of granules 301 or a stream of granules representing a portion of the group of granules 301 may be conveyed to a region wherein a plurality of nozzles (e.g., nozzles configured to provide controlled blasts of air or another fluid) are configured to direct granules to different paths based upon one or more granule characteristics.

In another aspect, the controller may be configured to control one or more aspects of the evaluation and/or separation processes. For example, in one embodiment, the controller 403 may be configured to generate one or more signals that may be used to control devices and/or sensors used in the evaluation and/or separation processes. For at least one embodiment, the controller 403 may generate a signal that can be used to calibrate and/or adjust the one or more sensors 401, the type of granules characteristics being detected, the conveying process parameters, the position and/or orientation of the one or more sensors, and the like. As such, the controller may be used to provide feedback through the process for real-time adjustments to the evaluation and/or separation processes.

Referring to FIG. 1, in certain embodiments, after separating the group of granules 301 into a plurality of collections, one or more additional processes may be conducted to facilitate the use of the granules and the formation of a building product. For example, one or more processes may include treating at least one collection of the granules, storing at least one collection of the granules, blending the one or more collection of granules with other particles and/or granules, applying the at least one collection of granules to a building product, or any combination thereof. In certain embodiments, at least a portion of the group of granules 301, such as one or more collection of granules, may be returned to an earlier step in the process.

Referring again to FIG. 1, the process can include dispensing the group of granules to assist with forming a building product at step 107. Empirical studies of the Applicants have found that the use of reclaimed granules adds notable complexity to the manufacturing process wherein conventional processes have been found to be insufficient to facilitate the formation of building products utilizing reclaimed granules on a commercial scale. For example, reclaimed granules may have certain amounts of residual asphalt that may create complexities-such as discoloration, mineral leaching, and agglomeration-associated with distribution of the granules effectively to form a suitable building product. Moreover, reclaimed granules likely come from a variety of sources, and therefore, may have a greater variation in their properties, such as density, particle size distribution, and composition, adding further complexity to the process for creating a suitable building product.

In one aspect, the process for forming a building product at step 107 may include at least obtaining data related to at least a portion of the group of granules at step 111 and providing the granules to a distribution device at step 113. In one particular embodiment, providing the granules to the distribution device may include a distribution device that is configured to change states based on the data related to at least a portion of the group of granules.

In an embodiment, the data related to at least a portion of the group of granules may be data related to the flow and/or distribution of the granules that may impact the manner in which the granules are distributed onto the building product. In one aspect, the data may be one or more granule distribution properties including for example, but not limited to, granule flow, granule density variation, particle size distribution, reclamation source, or any combination thereof. Granule distribution properties can be different than the granule characteristics which are generally focused on properties associated with a smaller group of granules, including for example individual granules, such that they may be suitably separated into one or more collections. Still, in one non-limiting embodiment, the data for selecting a state of the distribution device may also use one or more granule characteristics. For example, in a non-limiting embodiment, the data may include a granule characteristic, such as the asphalt content, and may also include a granule distribution property, such as a measurement of granule flow.

In accordance with one embodiment, the distribution device may be configured to change states based on the data associated with only one or more granule distribution properties. In another embodiment, the distribution device may be configured to change states based on the data associated with one or more granule distribution properties and one or more granule characteristics.

In one aspect, one or more granule distribution properties may be measured on the group of granules. The one or more granule distribution properties may be measured on the group of granules prior to group of granules reaching the distribution device. In one embodiment, certain granule distribution properties, such as density variation and/or reclamation source may be information that is provided when the group of granules is obtained from the reclaimed source. For example, the reclaimed granules may come with an information data sheet that provides certain granule distribution properties, which may be used for adaptation of the process for forming the building product using the reclaimed granules.

The group of granules provided for distribution onto the building product can include a group of granules having any one or more features of any of the groups of granules as provided in any of the embodiments herein. For example, the group of granules for distribution onto a building product may be a portion of the group of granules from earlier processes. For example, the group of granules from the evaluation and separation processes as described in accordance with embodiments herein may be the same group of granules provided to the distribution device. Still, in another embodiment, the group of granules that are provided to the distribution device may be a portion or a fraction of the group of granules that are handled in earlier processes as described in embodiments herein. For example, the group of granules provided to the distribution device may include one collection of granules that are obtained from the process of separating. In yet another embodiment, the group of granules provided to the distribution device may include a blend of virgin granules and reclaimed granules.

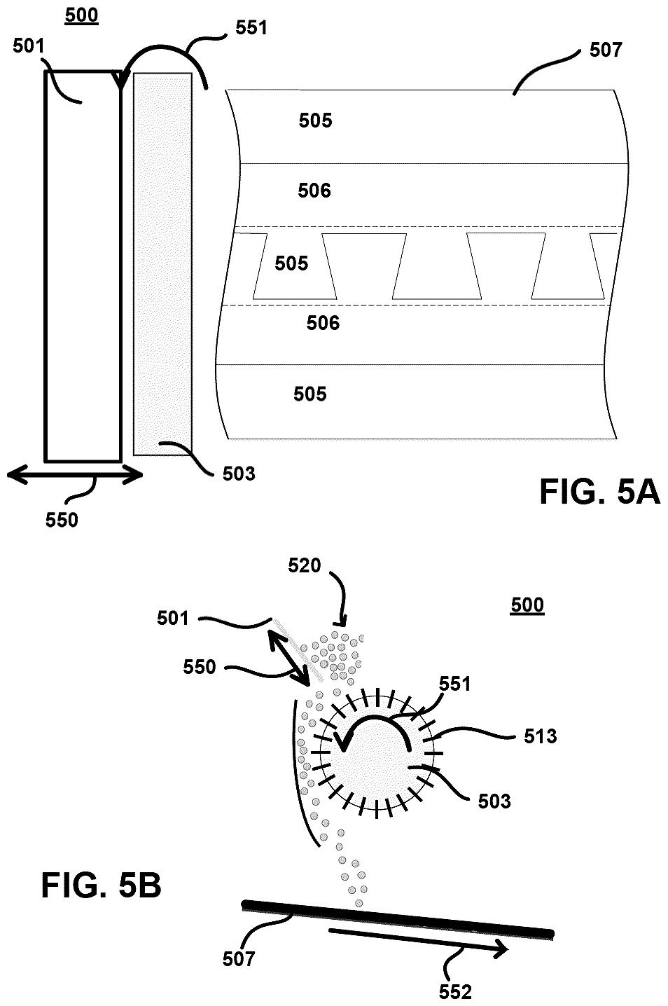

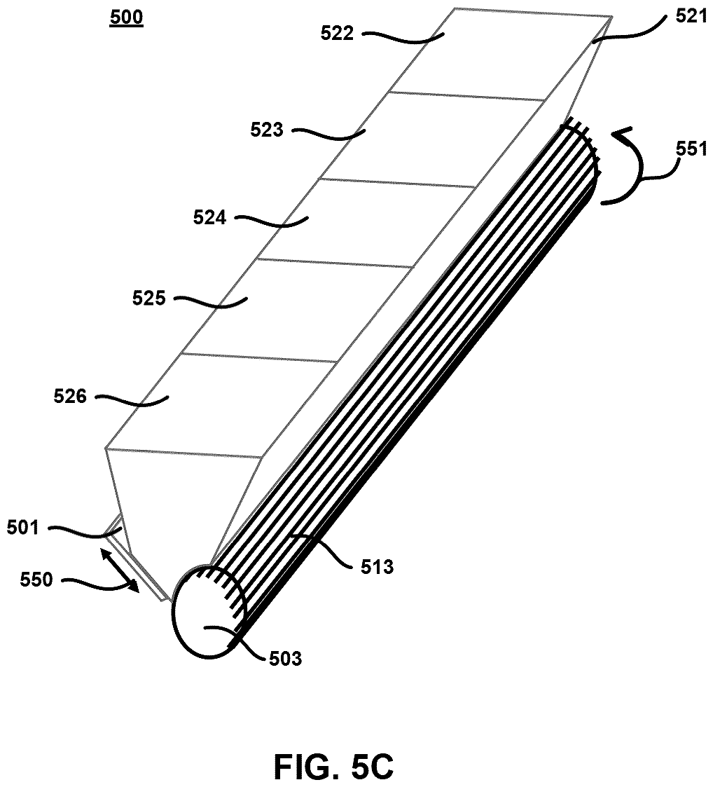

FIG. 5A includes the top down schematic conventional distribution device used to distribute granules onto a building product. FIG. 5B includes a side view illustration of the conventional distribution device illustrated in FIG. 5A. FIG. 5C includes an isometric view illustration of the conventional distribution device. As provided in the illustrated embodiments of FIGS. 5A-5C, a distribution device 500 can include a first portion 501 underlying a hopper 521 configured to hold granules in one or more separate containers 522, 523, 524, 525, and 526 prior to their distribution to a roller 503 underlying the hopper 521. The first portion 501 may be configured to translate in a direction generally 550 and the roller 503 may be configured to rotate generally, for example, in the direction 551. The roller 503 may include a plurality of flutes 513 extending radially outward and defining spaces between the flutes 513 to hold granules from the hopper 521 prior to deposition on the building product 507. The granules 520 may be dispensed from the distribution device 500, and more particularly from the one or more containers 522-526 of the hopper 521 to the roller 503 and dropped onto a building product 507 being translated relative to the distribution device 500 generally in the direction 552. As such, as the granules are distributed from the distribution device 500 onto the building product 507 and form a layer of granules on the surface of the building product 507.

The building product 507 may be divided into a plurality of sections, including for example, sections 505 and 506, which may define different portions of a building product after further processing. For example, in one embodiment sections 505 may define uncovered regions of a multilayer building product after the building product 507 is further processed and assembled. Sections 506 may define covered portions of a building product after the building product 507 is further processed and assembled. In one instance, the containers 522-526 may generally correspond in position to the positions of the sections 505 and 506 of the building product. It will be appreciated that the sections 505 and 506 of the building products 507 may be arranged in different ways depending upon the particular manufacturing process. Reference to the building product will be understood as reference to the finally-formed building product or intermediate product that is configured to form a building product after further processing. As understood in the industry, one or more layers asphalt-containing layers may be applied to a substrate, wherein the granules are applied to the asphalt-containing layer under conditions where the granules can adhere to the asphalt-containing layer.

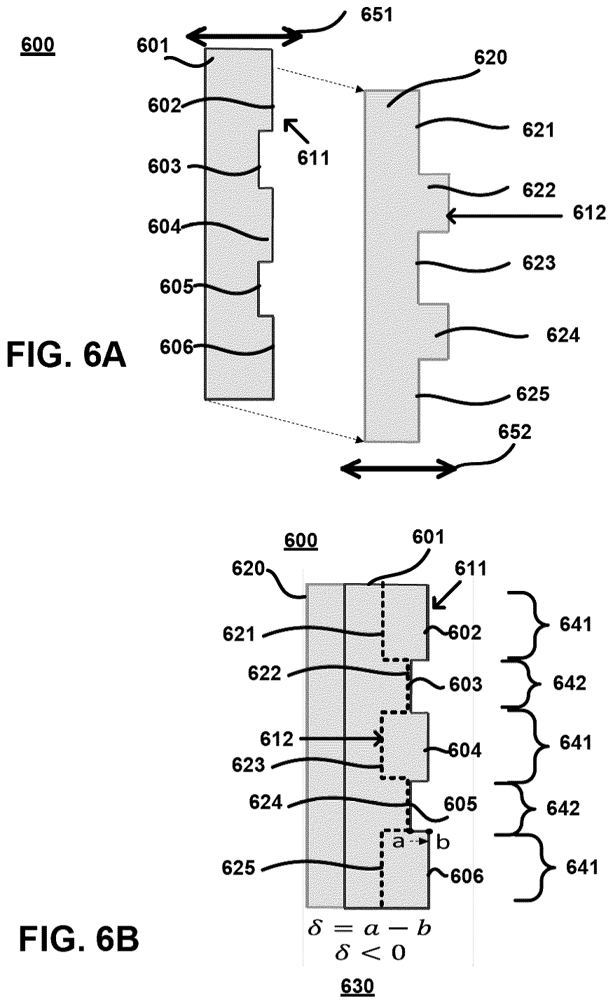

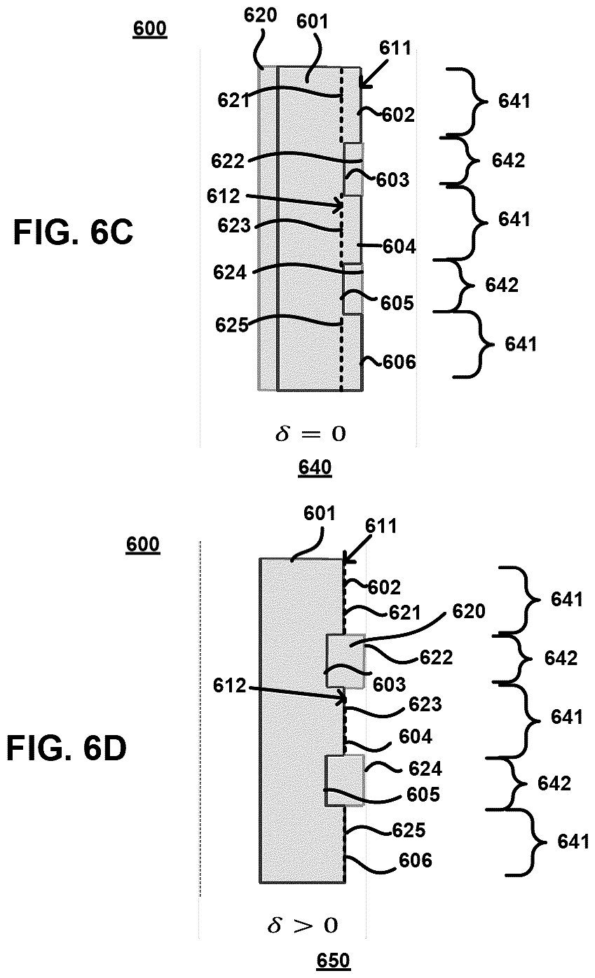

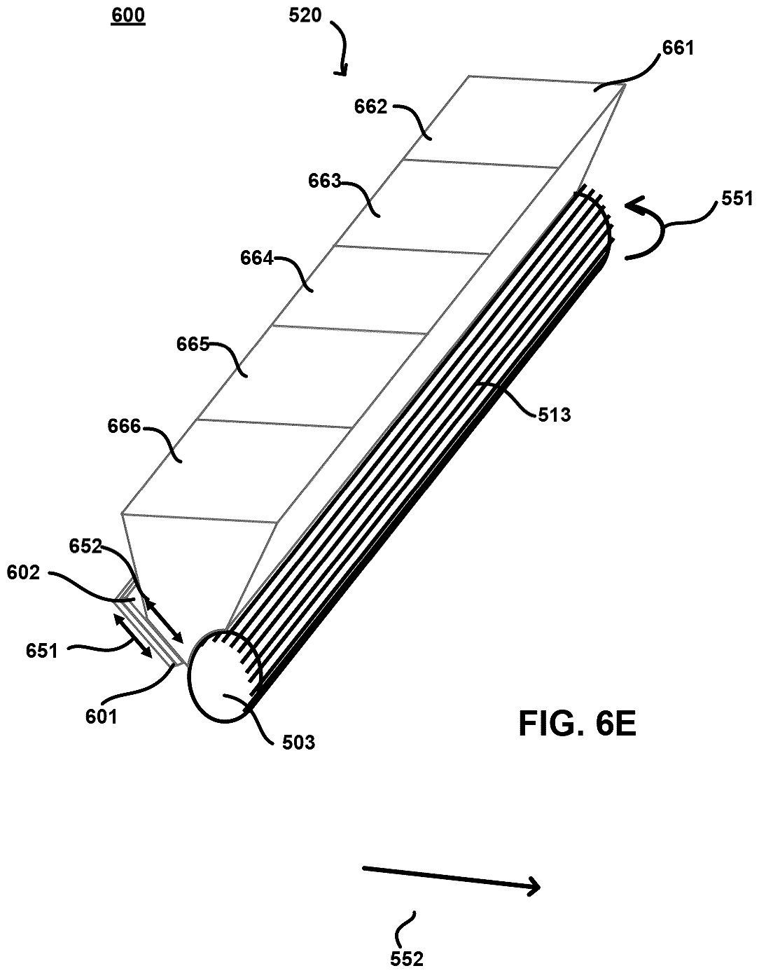

FIG. 6A includes an illustration of a portion of a distribution device according to an embodiment. As illustrated, the distribution device 600 may include a first portion 601 and a second portion 620. According to an embodiment, the first portion 601 may have a leading edge 611 including a first region 602, a second region 603, a third region 604, a fourth region 605, and a fifth region 606. In another embodiment, the second portion 620 may have a leading edge 612 including a first region 621, a second region 622, a third region 623, a fourth region 624, and a fifth region 625.

According to an embodiment, the first portion 601 may be configured to translate in the direction 651. In another instance, the second portion 620 may be configured to translate generally in the direction 652.

In an assembled condition, the first portion 601 can be configured to overlie the second portion 620 and the first and second portions 601 and 602 may be configured to move relative to each other control an opening size between a bottom opening of a hopper 661 and a roller 503 (see, FIG. 6E) to control the flow of granules to a building product. In a more particular embodiment, the position of the first portion 601 relative to the second portion 620 may also control a relative position between one or more regions of the leading edges 611 and 622 of the first and second portions 601 and 620, which may further control the flow of the granules through the distribution device 600 and the distribution of the granules from the distribution device 600 onto one or more sections of the building product.

FIG. 6B includes an illustration of a portion of a distribution device in one state according to an embodiment. According to one aspect, the distribution device 600 can include adaptive control that facilitates control of the flow and/or distribution of the granules. For example, in one embodiment, the distribution device 600 can be configured to change states to facilitate a change of the flow of the granules and/or distribution of granules within one or more regions of the distribution device 600. In one embodiment, the state of the distribution device 600 may be based upon the position of the first portion 601 relative to the second portion 620.

For example, as provided in the illustrated embodiment of FIG. 6B, in state 630, the second portion 620 can be positioned relative to the first portion 601 such that the leading edge 611 of the first portion 601 in the regions 602, 604, and 606 is advanced beyond the leading edge 612 of the second portion 620 in the regions 621, 623, and 625. In such an embodiment, the leading edge 612 of the second portion 620 may be aligned with the leading edge 611 of the first portion 601 in the regions 603 and 604. In the state 630, the distribution device may have a relative relationship between leading edges 611 and 612 as defined as “a” to “b”, wherein the difference is defined as the delta (δ). In the embodiment related to state 630, the delta is less than 0, wherein the leading edge 611 of the first portion within regions 602, 604 and 606 is covering the leading edge 612 in the regions 621, 623 and 625 of the second portion 620.

In the embodiment of FIG. 6B for state 630 of the distribution device 600, the flow of granules through the distribution device 600 in the regions 641 may differ as compared to the flow rates of the granules in the regions 642. According to one embodiment, the variable contours of the leading edges 611 and 612 of the first and second portions 601 and 620 may facilitate varied flow rates through the regions 641 and 642. In still another embodiment, the relative position of the first and second portions 601 and 620 as defined by the delta (δ) may also facilitate control of the flow rate of granules through each of the regions 641 and 642 of the distribution device 600. Such elements may facilitate control of the flow of granules through the distribution device 600 within different region 641 and 642 and further facilitate control of the distribution of the granules onto a building product, and more particularly, control of the distribution of granules within different sections of a building product.

More particularly, the variable contours of the leading edges 611 and 612 of the first and second portions 601 and 602 define varied opening sizes at the bottom of the hopper 621 and may further different size openings between an opening at the bottom of the hopper 621 and the flutes 513 of the roller 503. FIG. 6E includes an isometric view illustration of a distribution device according to an embodiment. In one instance, the flow rate of the granules from the bottom of the hopper 621 to the roller 503 can be controlled by controlling the relative positions of the first and second portions 601 and 602 relative to the positions of the flutes 513. In a more particular embodiment, the regions 641 and 642 of the first and second portions 601 and 602 may correspond to one or more containers 662, 663, 664, 665, and 666, of the container 661. In one embodiment, any of the containers 662-666 may include different types of granules and the flow rate of the granules from different containers 662-666 may be controlled by the relative positions of the first and second portions 601 and 602 relative to each other.

For example, in one particular instance, granules in containers 663 and 665 may include a group of granules including reclaimed granules consistent with any of the embodiments herein. In another non-limiting embodiment, the granules in the containers 662, 664, and 666 may be different than the granules included in the containers 663 and 665, including for example, but not limited to, virgin granules or granules having at least one different granule characteristic as compared to the granules in the containers 663 and 665. The different granules in the different containers may also correspond to the different regions of the building product. For example, the granules in the containers 663 and 665 may be configured for deposition to region 506 of the building product, whereas the containers 662, 664, and 666 may be aligned with region 505 of the building product. The relative positions of the first and second portions 601 and 602 may be adjusted to control the flow and deposition of the granules from the different containers 662-666 to facilitate suitable flow and deposition of the granules onto the regions 505 and 506 of the building product 507. Conventional systems do not allow for such selectivity and adjustability, which may cause undesirable distribution of groups of granules including reclaimed granules.

FIG. 6C includes an illustration of a distribution device in one state according to an embodiment. As provided in the illustrated embodiment of FIG. 6C, in state 640, the second portion 620 can be positioned relative to the first portion 601 such that the leading edge 611 of the first portion 601 in the regions 602, 604, and 606 is advanced beyond the leading edge 612 of the second portion 620 in the regions 621, 623, and 625. As further illustrated, in the state 640, the leading edge 612 of the second portion 620 in the regions 622 and 624 can be advanced beyond the leading edge 611 of the first portion 601 in the regions 603 and 605. In one particular instance, the leading edge 611 of the first portion 601 in regions 602, 604, and 606 may be substantially aligned with the leading edge 612 of the second portion 620 in the regions 622 and 624. In the state 640, the distribution device may have a relative relationship between leading edges 611 and 612 as defined as “a” to “b”, wherein the delta (δ) is substantially 0.

In the embodiment of FIG. 6C for state 640 of the distribution device 600, the flow of granules through the distribution device in the regions 641 may differ as compared to the flow rates of the granules in the regions 642. According to one embodiment, the variable contours of the leading edges 611 and 612 of the first and second portions 601 and 620 may facilitate varied flow rates through the regions 641 and 642. In still another embodiment, the relative position of the first and second portions 601 and 620 as defined by the delta (δ) may also facilitate control of the flow rate of granules through each of the regions 641 and 642 of the distribution device 600. Such elements may facilitate control of the flow of granules through the distribution device 600 within different region 641 and 642 and further facilitate control of the distribution of the granules onto a building product, and more particularly, control of the distribution of granules within different regions (e.g., 505 and 506) of a building product.

Furthermore, in a comparison of the distribution device between state 630 and 640, the flow rates through the regions 641 and 642 may differ for the different states 630 and 640. For example, the size of the opening between the bottom of the hopper 661 and the roller 503 in region 641 may be smaller in state 630 as compared to state 640, which may facilitate adaptive control of the flow of the granules through the distribution device 600. In yet another aspect, the size of the opening between the bottom of the hopper 661 and the roller 503 in region 642 may be smaller in state 630 as compared to state 640, which may facilitate adaptive control of the flow of the granules through the distribution device 600.

FIG. 6D includes an illustration of a distribution device in one state according to an embodiment. As provided in the illustrated embodiment of FIG. 6D, in state 650, the second portion 620 can be positioned relative to the first portion 601 such that the leading edge 611 of the first portion 601 in the regions 602, 604, and 606 can be substantially aligned with the leading edge 612 of the second portion 620 in the regions 621, 623, and 625. As further illustrated, in the state 650, the leading edge 612 of the second portion 620 in the regions 622 and 624 can be advanced beyond the leading edge 611 of the first portion 601 in the regions 603 and 605. In the state 650, the distribution device may have a relative relationship between leading edges 611 and 612 as defined as “a” to “b”, wherein the delta (δ) is greater than 0.

In the embodiment of FIG. 6D for state 650 of the distribution device 600, the flow of granules through the distribution device in the regions 641 may differ as compared to the flow rates of the granules in the regions 642. According to one embodiment, the variable contours of the leading edges 611 and 612 of the first and second portions 601 and 620 may facilitate varied flow rates through the regions 641 and 642. In still another embodiment, the relative position of the first and second portions 601 and 620 as defined by the delta (δ) may also facilitate control of the flow rate of granules through each of the regions 641 and 642 of the distribution device 600. Such elements may facilitate control of the flow of granules through the distribution device 600 within different region 641 and 642 and further facilitate control of the distribution of the granules onto a building product, and more particularly, control of the distribution of granules within different sections of a building product.

In a comparison of the distribution device between state 630 and 650, the flow rates through the regions 641 and 642 may differ for the different states 630 and 650. For example, the size of the opening between the bottom of the hopper 661 and the roller 503 in region 641 may be smaller in state 630 as compared to state 650, which may facilitate adaptive control of the flow of the granules through the distribution device 600. In yet another aspect, the size of the opening between the bottom of the hopper 661 and the roller 503 in region 642 may be smaller in state 630 as compared to state 650, which may facilitate adaptive control of the flow of the granules through the distribution device 600.

The adaptive control of the distribution device may be controlled entirely or partially by an operator or automated via a computing system. Information related to at least a portion of the group of granules 301 may be used to change states of the distribution device. According to one embodiment, operator may be provided with information related to at least a portion of the granules of the group of granules to facilitate evaluating whether to change a state of the distribution device. In still another embodiment, one or more computerized controllers may be connected to the distribution device and capable of actuating the distribution device between two or more states based on information related to at least a portion of the granules of the group of granules. In still another embodiment, the adaptive control of the distribution device between two or more stages may utilize a combination of operator control and computerized controllers. For example, information may be collected related to at least a portion of the granules of the group of granules, and a computerized controller may interface with an operator through an interface to provide a suggested change, and the change may be confirmed by the operator and changed by the controller or the operator may confirm and actuate the distribution device by hand to select the preferred state.

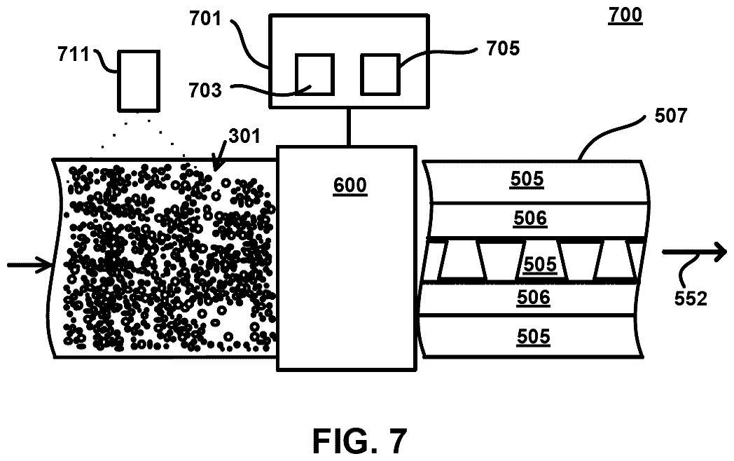

FIG. 7 includes a schematic of a process for distributing a group of granules according to an embodiment. According to one embodiment, the system 700 may include a group of granules 301 configured to be transported or conveyed to a distribution device 600 for distribution onto one or more portions of a building product 507. The system 700 may include one or more sensors 711 configured to detect or measure one or more granule distribution properties of the group of granules 301, which may facilitate operation of the distribution device 600.

In one aspect, the system 700 may include a controller 701, which may be communicatively coupled to the one or more sensors 711. In one embodiment, the system 700 may include a memory 703 and a processor 705. As will be appreciated, the memory 703 and/or processor 705 may be part of the controller 701 or may be separate devices that are in communication with each other through a wired or wireless connection. According to another aspect, the one or more sensors 711 can be communicatively coupled to the processor 705, memory 703 and processor 705 through a wired or wireless connection.

In a particular embodiment, the controller 701 may be configured to execute instructions from the processor 705 based on information related to at least a portion of the granules from the group of granules 301. In a more particular instance, the controller 701 may be configured to execute instructions for changing the state of the distribution device 600 based on information related to at least a portion of the granules of the group of granules 301. As provided herein, the change in state of the distribution device 600 may facilitate improved flow of the granules through one or more regions of the distribution device and may also facilitate improved distribution of the granules to one or more sections of a building product. According to one embodiment, the information related to at least a portion of the granules from the group of granules may include a) one or more granule distribution properties from the group of granule flow, granule density variation, particle size distribution, reclamation source, or any combination thereof; b) one or more granule characteristics from the group of color, density, average size, shape, composition, asphalt content, particle size distribution; or any combination of two or more elements from a) and b). The information used by the controller 701 may be obtained from any one or more sensors, including for example, but not limited to sensors 401 and/or 711 used at one or more stages of the processes of the embodiments herein.

For example, the one or more sensors 711 may be configured to provide real-time information related to at least a portion of the granules of the group of granules 301 that may be used to facilitate real-time adaptation of the state of the distribution device 600. As will be appreciated, the one or more sensors 711 may be situated or positioned upstream of the distribution device 600, such that information (e.g., one or more granular distribution properties) is gathered on at least a portion of the group of granules 301 prior to the group of granules 301 reaching the distribution device 600.

In one aspect, the one or more sensors 711 can include sensors suitable for evaluating one or more aspects of at least a portion of the granules of the group of granules 301. For example, in one non-limiting embodiment, the one or more sensors 711 may include an optical sensor configured to create digital images of at least a portion of the granules from the group of granules 301. In one embodiment, the optical sensor may be configured to operate over a range of wavelengths within the visible spectrum. In still another embodiment, the optical sensor operates using wavelengths including and/or outside of the visible spectrum. For example, one optical sensor may use infrared or UV wavelengths for evaluating at least one granule characteristic of the group of granules 301. The one or more sensors 711 can be configured to evaluate, store, and send the information as digital information to one or more devices, including for example, the controller 701, the memory 703 and/or the processor 705.

In one embodiment, the group of granules 301 conveyed to the distribution device 600 may be divided into two or more separate collections, which can be conveyed separately and directly to the distribution device 600 or stored in one or more hoppers prior to being fed to the distribution device 600. In one instance, the separate collections may include granules of different granule characteristics and/or granule distribution properties. The separate collections may correspond to different regions within the distribution device (e.g., regions 641 and 642), which may also correspond to different sections of the building product (e.g., 505 and 506). In certain instances, granules of different granule characteristics may be separated into separate collections prior to the distribution device 600. The granules within the separate collections may be evaluated for one or more granule distribution properties, wherein such information is communicated to a controller configured to change a state of the distribution device 600. The distribution device 600 may change state depending upon the one or more granule distribution properties of the granules from one or more collections.

In a particular non-limiting embodiment, a first collection of granules may include a higher content of reclaimed granules as compared to a second collection. In one embodiment, the first collection of granules contains at least 18 wt % of reclaimed granules having an average residual asphalt of at least 0.1 wt % for a total weight of the reclaimed granules, such as at least 20 wt % of the granules comprise reclaimed granules for a total weight of the granules or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 98 wt %. In one embodiment, the first collection of granules may include a ratio of reclaimed granules to virgin granules of between 1:0 and 20:1, such as 1.5:1 and 10:1, or 5:1 and 10:1. The granules of the first collection may be directed to one particular region (e.g., 642) of the deposition device 600 to facilitate deposition onto a particular section (e.g., 506) of the building product 507 corresponding to a covered region. The granules of the second collection may be directed to a different region (e.g., 641) of the deposition device 600 as compared to the first collection, such that the granules of the second collection are configured to be deposited onto a different section (e.g., 505) of the building product 507 as compared to the first collection, wherein the different section may correspond to a visible portion of the building product 507.

Referring again to FIG. 1, after dispensing the particles, they may be used to form a building product as provided at step 107 and described in the embodiments herein. According to an embodiment, one type of building product that can include the group of granules may include a roofing product. In one aspect, the roofing product may include a roofing membrane or roofing shingle. In one aspect, the roofing shingle may have a multilayered construction including a lower layer and an upper layer. In one embodiment, the upper layer may overlie a portion of the lower layer to define a covered region on the lower layer. In one aspect, the covered region may include a headlap portion as known in the art. The lower layer can include a headlap and a plurality of tabs extending from the headlap. The upper layer can include one or more fingers disconnected from one another. The one or more fingers can be arranged along an upper surface of the lower layer-particularly, along the tabs and headlap. In an embodiment, each tab of the lower layer can include no more than one finger, but certain tabs may be free, or essentially free, (such as devoid) of a finger. In certain instances, at least one of the fingers can extend across an entire width of the lower layer. In other embodiments, at least one of the fingers can extend a distance different than the width of the lower layer, such as less than the width of the lower layer. An impact resistant material can be coupled to the lower layer of the roofing shingle, providing dampening against impacting objects.

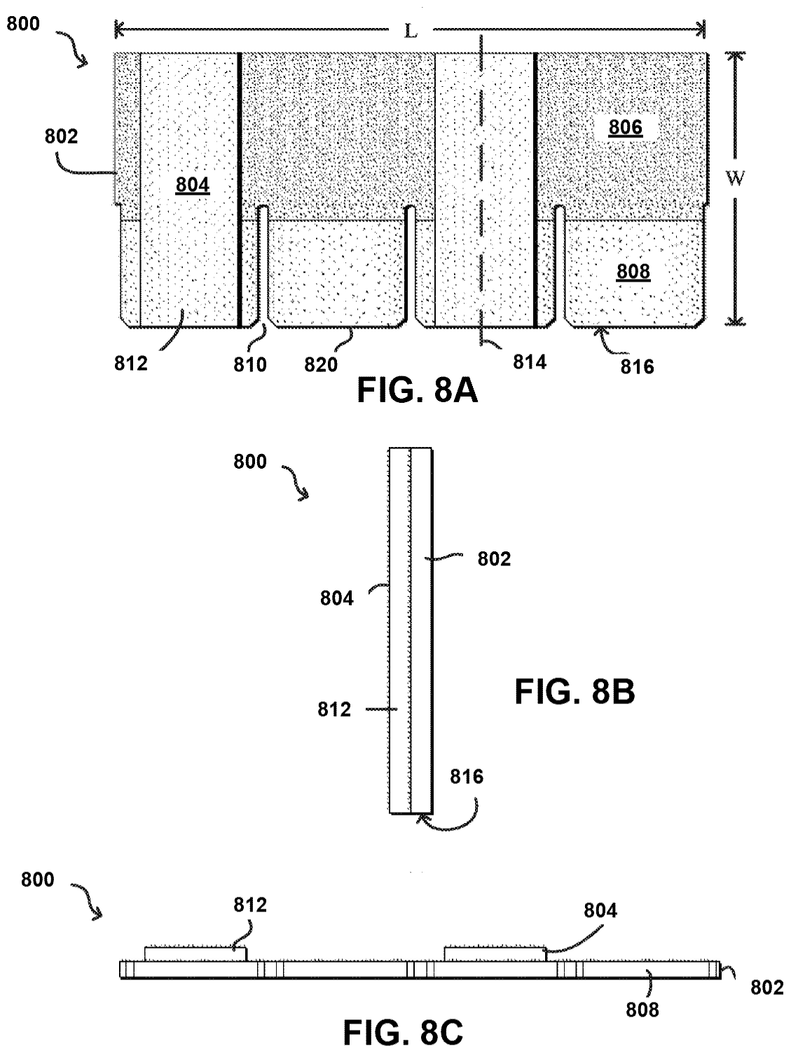

Referring to FIGS. 8A, 8B, and 8C, a roofing shingle 800 (hereinafter, “shingle”), in accordance with embodiments described herein, generally includes a lower layer 802 and an upper layer 804. In an embodiment, the lower layer 802 may form a lowermost layer of the shingle 800. In another embodiment, the upper layer 804 may form an uppermost layer of the shingle 800. In a particular instance, the shingle 800 can be free, or essentially free, (such as devoid) of additional layers such as a tertiary layer along the lowermost surface of the lower layer 802, along the uppermost surface of the upper layer 804, or along both the lowermost surface of the lower layer 802 and the uppermost surface of the upper layer 804. In another instance, one or more elements can be positioned along the lowermost surface of the lower layer 802, along the uppermost surface of the upper layer 804, or along both the lowermost surface of the lower layer 802 and the uppermost surface of the upper layer 804. Examples of laminated shingle configurations are described in U.S. Pat. No. 6,145,265, which is incorporated herein in its entirety.

The lower layer 802 can include a headlap 806 extending along a length, L, and at least partially along a width, W, of the shingle 800 and one or more tabs 808 extending from the headlap 806. The headlap 806 can be polygonal such as rectangular, or generally rectangular. Installed, the headlap 806, or a portion thereof, is typically covered by an overlying shingle 800.

In an embodiment, the lower layer 802 may include only one tab 808 extending between a left edge and a right edge of the shingle 800. That is, the shingle 800 may be free, or essentially free, of slots otherwise separating adjacent tabs. In another embodiment, the lower layer 802 may include a plurality of tabs 808, such as two tabs, three tabs, four tabs, or five tabs extending from the headlap 806. In yet another aspect, the lower layer 802 can include more than five tabs, such as at least six tabs, at least seven tabs, at least eight tabs, at least nine tabs, or even at least ten tabs.

In a particular embodiment, the tabs 808 can all extend equidistance from the headlap 806. For example, the tabs 808 may extend at least 5% of the width, W, of the shingle 800, such as at least 10% W, at least 20% W, at least 30% W, at least 40% W, or even at least 50% W. In an embodiment, the tabs 508 may extend less than W, such as less than 99% W, less than 90% W, less than 80% W, less than 70% W, or less than 60% W.

Still, it will be appreciated that in certain instances, the tabs 808 can extend different distances from the headlap 806 toward a butt end 816 of the shingle 800. In some embodiments, the butt end 816 may be variegated.

Referring again to FIGS. 8A-8C, the tabs 808 can extend from the headlap 806 in a uniform, or generally uniform, direction with respect to one other. Adjacent tabs 808 can be spaced apart by slots 810 extending parallel, or generally parallel, with the width, W, of the shingle 800. In certain embodiments, the slots 808 can have uniform characteristics with respect to one another. For example, the slots 808 can all have a same width, as measured parallel with the width, W, of the shingle 800, a same length, as measured perpendicular to the width, W, a same area, a same shape as compared to one another, or a combination thereof. In an embodiment, at least one of the slots 810 can extend past the tabs 808 into the headlap 806. In a particular instance, the at least one slot 810 can extend at least 1% into the width of the headlap, such as at least 5% into the width of the headlap, at least 10% into the width of the headlap, or even at least 25% of the width of the headlap. In another instance, the at least one slot 810 can extend no greater than 75% the width of the headlap, no greater than 50% of the width of the headlap, or no greater than 30% the width of the headlap.

In one non-limiting embodiment, at least one of the slots 810 can extend a different distance into the headlap 806 than a slot 810 along the same or different shingle 800. In a different embodiment, all of the slots 810 can extend a same distance into the headlap 806. At least one of the slots 810 can terminate with a rounded end, a polygonal end, or an end having rounded and polygonal attributes. As illustrated in FIG. 8A, the slot 810 can terminate at the butt end 816 of the shingle 800 with a flared opening.

In an embodiment, at least one of the slots 810 may be closed, or fully surrounded by portions of the lower layer 802. That is, the at least one slot 810 may have a perimeter defined entirely by the lower layer 802, i.e., the slot is not open and does not terminate at the butt end 816. In a particular embodiment, the shingle 800 can include a combination of open and closed slots 810. In another particular embodiment, adjacent tabs 808 can be spaced apart by multiple slots 810, such as multiple closed slots. The closed slots can optionally all lie along a same line extending from the butt end 816 of the shingle 800 to the headlap 806.

In a particular instance, one or more of the slots 810 can be slits having no discernable length, as measured parallel with a length, L, of the shingle 800. Slits can break surface textures, changing aesthetic appearance of the shingle 800 without material removal. In certain embodiments, the slots 810 can have different lengths as compared to one another, as measured parallel with the length, L, of the shingle 800. In other embodiments, the slots 810 can have the same, or relatively similar, lengths as one another, as measured parallel with the length, L.

The shingle 800 in accordance with embodiments described herein can further include fingers 812 as part of the upper layer 804. According to an embodiment, fingers 812 can selectively overlie a portion of or all of the tabs 808. In one embodiment, each finger 812 can extend from the headlap 806 to the butt end 816 of the respective tabs 808. In one aspect, the upper layer 804 can include one or more fingers 812, such as for example, at least one finger, at least two fingers, at least three fingers, at least four fingers, or even at least five fingers. Each finger of the one or more fingers 812 can be aligned with a tab 808 of the lower layer 802. In an embodiment, each of the one or more fingers 812 may be disposed on one tab 808. In another embodiment, each tab 808 may include no more than one finger 812. In certain embodiments, each tab 808 may include one finger 812. In certain other instances, the total number of tabs 808 may be different than the total number of fingers 812. The disclosure is not intended to be limited to this exemplary configuration and other arrangements between tabs 808 and fingers 812 are contemplated by this disclosure.

By way of a non-limiting embodiment, the fingers 812 can be attached to the lower layer 802, for example, by an adhesive, mechanical fastener, mechanical deformation, threaded or non-threaded fasteners, or any combination thereof.

The relative width of the tabs 808 and fingers 812 may be varied for the desired construction and/or aesthetic. For example, the tabs 808 may have different widths as compared to each other.

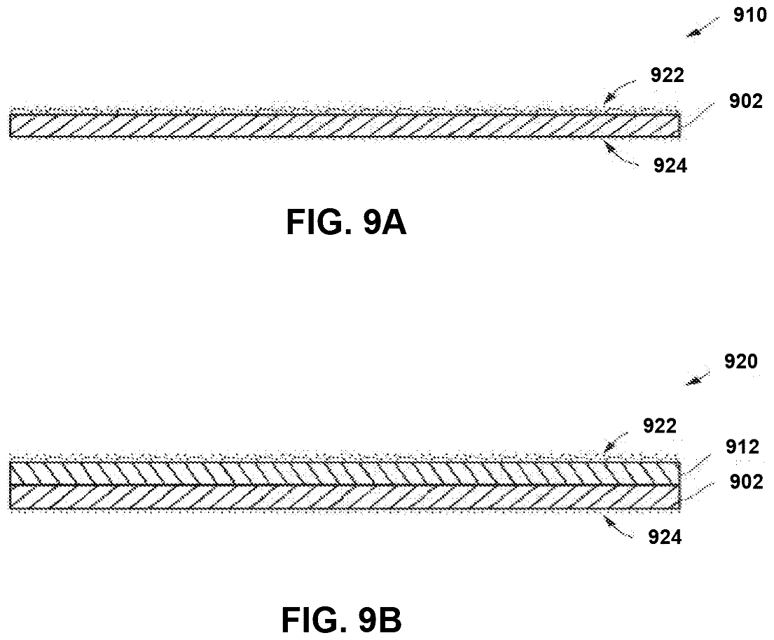

FIG. 9A includes a cross-sectional illustration of a roofing product, such as a roofing membrane, according to an embodiment. The roofing product 910 can include a coated base material 902 that may include a roofing-grade asphalt mixture. Roofing granules 922 may be applied to a principal surface of the coated base material 902. The roofing granules 922 can include the group of granules as provided in the embodiments herein. In certain embodiments, a parting agent 924 may be applied to an opposite principal surface of the coated based material 902, which may facilitate the application of the product to a surface.

FIG. 9B includes a cross-sectional illustration of a roofing product, such as a roofing membrane, according to an embodiment. As illustrated, the roofing product 920 can include a coated base material 902, roofing granules 922 and parting agent 924 as previously described with respect to the roofing product of FIG. 9A. The roofing product 920 may further include a roofing-grade asphalt coating 921 that is disposed between the coated base material 902 and the roofing granules 922. The roofing-grade asphalt coating 912 can include a roofing-grade asphalt mixture. The roofing-grade asphalt coating 912 may have substantially the same composition or a different composition as compared to the roofing-grade asphalt mixture within the coated base material 902.

According to one aspect, the embodiments herein facilitate commercial scale formation of building products having granules with particular contents of reclaimed granules and improved distribution of granules including reclaimed granules. In a particular instance, a building product can be formed including at least 18 wt % reclaimed granules for the total weight of granules, wherein the reclaimed granules have a residual asphalt content as provided in embodiments herein. The reclaimed granules can have any one or more features of reclaimed granules as provided in the embodiments herein.

In another non-limiting embodiment, a building product may include a multi-layered roofing product having a first layer and a second layer, wherein at least a portion of the second layer is overlying the first layer and defining a covered region. In one particular instance, the covered region may be a headlap region a roofing product, and the headlap region may include a minimum content of reclaimed granules with one or more features related to the content and/or distribution of the granules.

The processes herein may facilitate the formation of building products having one or more covered regions including a group of granules with a particular content of reclaimed granules wherein the amount of agglomeration is measurable less as compared to products made through conventional techniques.

In yet another aspect, a building product may be formed having a covered region and a particular content of reclaim granules, where in the granules in the covered region have an proved distribution as compared to products made through conventional techniques.

In still another aspect, a building product may be formed having a covered region with a minimum content of reclaimed granules, wherein the granules in the covered region may have a particular density variation, as reclaimed granules may come from a variety of sources. For example, in one embodiment, the density variation can be at least 0.20 g/cc, such as at least 0.22 g/cc or at least 0.24 g/cc or at least 0.26 g/cc or at least 0.28 g/cc or at least 0.30 g/cc or at least 0.32 g/cc or at least 0.34 g/cc or at least 0.36 g/cc or at least 0.38 g/cc or at least 0.40 g/cc or at least 0.42 g/cc or at least 0.44 g/cc or at least 0.46 g/cc or at least 0.48 g/cc or at least 0.50 g/cc or at least 0.52 g/cc or at least 0.54 g/cc or at least 0.56 g/cc or at least 0.58 g/cc or at least 0.60 g/cc or at least 0.62 g/cc or at least 0.64 g/cc or at least 0.66 g/cc at least 0.68 g/cc or at least 0.70 g/cc or at least 0.80 g/cc or at least 0.90 g/cc. Still, in one non-limiting embodiment, the density variation of the group of granules including reclaimed granules can be not greater than 5 g/cc, such as not greater than 4 or not greater than 3 or not greater than 2 or not greater than 1.8 or not greater than 1.6 or not greater than 1.5 or not greater than 1.4 or not greater than 1.3 or not greater than 1.2 or not greater than 1. It will be appreciated that the group of granules may have a density variation within a range including any of the minimum and maximum values noted above, including for example, but not limited to, within a range of at least 0.20 g/cc and not greater than 5 g/cc, such as within a range of at least 0.22 g/cc and not greater than 4 g/cc or even within a range including at least 0.24 g/cc and not greater than 2 g/cc. In one embodiment, the density can be between 1 g/cc and 8 g/cc, such as between 2 g/cc and 4 g/cc. As used herein, reference to density variation is reference to the maximum and minimum values of density for a statistically relevant sample size of granules of the group of granules as measured using a pycnometer utilizing nitrogen.

For one aspect, a building product may be formed having a covered region with a minimum content of reclaimed granules, wherein the granules in the covered region have a particular adhesion to the product as measured by granule loss. For example, in one embodiment, the granule loss can be not greater than 0.7 g. Granule loss is measured by subjecting a sample to 50 forward and backward cycles (1 cycle is a forward and backward motion) of scrubbing by a machine operated, wire brush. Samples are weighed before and after scrubbing. The weight lost is recorded as the granule loss of the granules to the product.

According to another embodiment, the granules may include a particle having a core and at least a partial coating overlying a surface of the particle. The core may include an inorganic material. The inorganic material may include a material selected from the group of an oxide, carbide, nitride, boride, or any combination thereof. The coating may include an organic material, and inorganic material or any combination thereof. In one embodiment, the coating may include a pigment.

According to another embodiment, the granules may have a particular average density, such as an average density within a range of at least 2.0 g/cc and not greater than 4.0 g/cc.

In yet another aspect, the granules may have a particular particle size. For example, in one embodiment, the granules may have an average particle size (D50) within a range of at least 25 microns to not greater than 4 mm.

The granules may be solid particulate having essentially little to no porosity, such as a porosity of not greater than 5 vol % for a total volume of the granules, such as not greater than 4 vol % or not greater than 3 vol % or not greater than 2 vol % or not greater than 1 vol % for a total volume of the granules.

In another aspect, the granules may include some porosity, such that they may be a porous particulate material. For example, the granules may have a porosity of at least 6 vol % for a total volume of the granules, such as at least 10 vol % or at least 20 vol % or at least 30 vol % or at least 50 vol %. In one non-limiting embodiment, the granules may have a porosity of not greater than 70 vol % for a total volume of the granules, such as not greater than 60 vol % or not greater than 50 vol %. It will be appreciated that the porosity can be within a range including any of the minimum and maximum percentages noted above.

In yet another instance, the granules may include one or more biocidal materials including for example an inorganic and/or organic compound adapted to limit or to prevent microorganism growth, in particular algae.

In another aspect, the granules may have a color variation having L* values between 30-80 using the 1976 CIE L*a*b* color space.

### Embodiments

Embodiment 1: A building product comprising: a body including a covered region including granules, wherein at least 18 wt % of the granules comprise reclaimed granules having an average residual asphalt of at least 0.1 wt % for a total weight of the reclaimed granules.

Embodiment 2: The building product of any one or more embodiments, wherein at least 20 wt % of the granules comprise reclaimed granules for a total weight of the granules or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 98 wt %.

Embodiment 3: The building product of any one or more embodiments, wherein the reclaimed granules include at least 0.3 wt % residual asphalt on an exterior surface for a total weight of the reclaimed granules, or at least 0.5 wt % or at least 1 wt % or at least 2 wt % or at least 3 wt % or at least 4 wt % or at least 5 wt % or at least 6 wt % or at least 7 wt % or at least 8 wt % or at least 9 wt % or at least 10 wt % or at least or at least 15 wt %, or at least 20 wt % or at least 25 wt % or at least 30 wt % or at least 35 wt % or at least 40 wt % or at least 45 wt % or at least 50 wt %.

Embodiment 4: The building product of any one or more embodiments, wherein the reclaimed granules include not greater than 90 wt % residual asphalt on an exterior surface for a total weight of the reclaimed granules, or not greater than 80 wt % or not greater than 70 wt % or not greater than 60 wt % or not greater than 50 wt % or not greater than 40 wt % or not greater than 30 wt % or not greater than 20 wt % or not greater than 15 wt % or not greater than 10 wt % or not greater than 8 wt % or not greater than 6 wt %.

Embodiment 5: The building product of any one or more embodiments, further comprising a multilayered roofing product including a first layer and a second layer, wherein at least a portion of the second layer is overlying the first layer and defining the covered region.

Embodiment 6: The building product of any one or more embodiments, wherein the covered region includes a headlap region of a roofing shingle.

Embodiment 7: The building product of any one or more embodiments, wherein the granules in the covered region have a density variation of at least 0.2 g/cc and not greater than 5 g/cc.

Embodiment 8: The building product of any one or more embodiments, wherein the granules further comprise an adhesion of not greater than 0.7 g.

Embodiment 9: The building product of any one or more embodiments, wherein the granules further comprise at least one of: a particle having a core and at least a partial coating overlying a surface of the particle; an average density within a range of at least 2.0 g/cc and not greater than 4.0 g/cc; an average particle size (D50) within a range of at least 25 microns to not greater than 4 mm; a solid particulate material; a porous particulate material; an inorganic material including at least one material from the group of oxides, carbides, nitrides, borides, or any combination thereof; a biocidal material; a color variation having L* values between 30-80; or any combination of two or more of any of the foregoing.

Embodiment 10: The building product of any one or more embodiments, wherein the granules overlie at least 50% of the surface area of the covered region, or at least 60% or at least 70% or at least 80% or at least 90% or at least 95%.

Embodiment 11: A building product comprising: a body including a covered region including granules, wherein at least 1 wt % of the granules comprise reclaimed granules having an average residual asphalt of at least 0.1 wt % for a total weight of the granules and a density variation of at least 0.2 g/cc and not greater than 5 g/cc.

Embodiment 12: The building product of any one or more embodiments, wherein at least 5 wt % of the granules comprise reclaimed granules for a total weight of the granules or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 98 wt %.

Embodiment 13: The building product of any one or more embodiments, wherein the reclaimed granules include at least 0.3 wt % residual asphalt on an exterior surface for a total weight of the reclaimed granules, or at least 0.5 wt % or at least 1 wt % or at least 2 wt % or at least 3 wt % or at least 4 wt % or at least 5 wt % or at least 6 wt % or at least 7 wt % or at least 8 wt % or at least 9 wt % or at least 10 wt % or at least or at least 15 wt %, or at least 20 wt % or at least 25 wt % or at least 30 wt % or at least 35 wt % or at least 40 wt % or at least 45 wt % or at least 50 wt %.

Embodiment 14: The building product of any one or more embodiments, wherein the reclaimed granules include not greater than 90 wt % residual asphalt on an exterior surface for a total weight of the reclaimed granules, or not greater than 80 wt % or not greater than 70 wt % or not greater than 60 wt % or not greater than 50 wt % or not greater than 40 wt % or not greater than 30 wt % or not greater than 20 wt % or not greater than 15 wt % or not greater than 10 wt % or not greater than 8 wt % or not greater than 6 wt %.

Embodiment 15: The building product of any one or more embodiments, further comprising a multilayered roof covering product including a first layer and a second layer, wherein at least a portion of the second layer is overlying the first layer and defining the covered region.

Embodiment 16: The building product of any one or more embodiments, wherein the covered portion includes a headlap portion of a roofing shingle.

Embodiment 17: The building product of any one or more embodiments, wherein the granules further comprise adhesion granule loss of not greater than 0.7 g.

Embodiment 18: The building product of any one or more embodiments, wherein the granules further comprise at least one of: a particle having a core and at least a partial coating overlying a surface of the particle; a density within a range of at least 2.0 g/cc to 4.0 g/cc; a particulate having an average particle size (D50) within a range of at least 25 microns to not greater than 4 mm; a solid particulate material; a porous particulate material; an inorganic material including at least one material from the group of oxides, carbides, nitrides, borides, or any combination thereof; a biocidal material; a color variation of at least L* of 30-80; or any combination of two or more of any of the foregoing.

Embodiment 19: The building product of any one or more embodiments, wherein the granules overlie at least 50% of the surface area of the covered region, or at least 60% or at least 70% or at least 80% or at least 90% or at least 95%.

Embodiment 20: A building product comprising a body including granules coupled to at least one surface of a body, wherein at least 18 wt % of the granules are reclaimed granules and wherein the granules comprise a density variation of at least 0.2 g/cc and not greater than 5 g/cc.

Embodiment 21: The building product of any one or more embodiments, wherein at least 1 wt % of the granules comprise reclaimed granules for a total weight of the granules or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 98 wt %.

Embodiment 22. The building product of any one or more embodiments, wherein the reclaimed granules include at least 0.3 wt % residual asphalt on an exterior surface for a total weight of the reclaimed granules, or at least 0.5 wt % or at least 1 wt % or at least 2 wt % or at least 3 wt % or at least 4 wt % or at least 5 wt % or at least 6 wt % or at least 7 wt % or at least 8 wt % or at least 9 wt % or at least 10 wt % or at least or at least 15 wt %, or at least 20 wt % or at least 25 wt % or at least 30 wt % or at least 35 wt % or at least 40 wt % or at least 45 wt % or at least 50 wt %.

Embodiment 23: The building product of any one or more embodiments, wherein the reclaimed granules include not greater than 90 wt % residual asphalt on an exterior surface for a total weight of the reclaimed granules, or not greater than 80 wt % or not greater than 70 wt % or not greater than 60 wt % or not greater than 50 wt % or not greater than 40 wt % or not greater than 30 wt % or not greater than 20 wt % or not greater than 15 wt % or not greater than 10 wt % or not greater than 8 wt % or not greater than 6 wt %.

Embodiment 24: The building product of any one or more embodiments, further comprising a multilayered roof covering product including a first layer and a second layer, wherein at least a portion of the second layer is overlying the first layer and defining the covered region.

Embodiment 25: The building product of any one or more embodiments, wherein the covered portion includes a headlap portion of a roofing shingle.

Embodiment 26: The building product of any one or more embodiments, wherein the granules further comprise a granule loss of not greater than 0.7 g.

Embodiment 27: The building product of any one or more embodiments, wherein the granules further comprise at least one of: a particle having a core and at least a partial coating overlying a surface of the particle; a density within a range of at least 2.0 g/cc to 4.0 g/cc; a particulate having an average particle size (D50) within a range of at least 25 microns to not greater than 4 mm; a solid particulate material; a porous particulate material; an inorganic material including at least one material from the group of oxides, carbides, nitrides, borides, or any combination thereof; a biocidal material; a color variation of at least L* of 30-80; or any combination of two or more of any of the foregoing.

Embodiment 28: The building product of any one or more embodiments, wherein the granules overlie at least 50% of the surface area of the covered region, or at least 60% or at least 70% or at least 80% or at least 90% or at least 95%.

Embodiment 29: A device for controlling the flow and/or distribution of granules for application onto a building product, wherein the device includes adaptive control configured to control the flow and/or distribution of granules, wherein the granules include at least 1 wt % reclaimed granules.

Embodiment 30: The device of any one or more embodiments, wherein the adaptive control is assisted by an operator.

Embodiment 31: The device of any one or more embodiments, wherein the adaptive control is at least partially automated.

Embodiment 32: The device of any one or more embodiments, wherein the adaptive control includes a change in state of the device to control a flow and/or distribution of granules to the building product.

Embodiment 33: The device of any one or more embodiments, wherein the change in state includes a change in the size of a distribution opening of the device.

Embodiment 34: The device of any one or more embodiments, wherein the change in state is at least partially based on at least: one or more granule distribution properties from the group of granule flow, granule density variation, particle size distribution, reclamation source, or any combination thereof; one or more granule characteristics from the group of color, density, average size, shape, composition, asphalt content, particle size distribution; any combination of the foregoing.

Embodiment 35: The device of any one or more embodiments, wherein the change in state is at least partially based on at least: one or more granule distribution properties from the group of granule flow, granule density variation, particle size distribution, reclamation source, or any combination thereof; and one or more granule characteristics from the group of color, density, average size, shape, composition, asphalt content, particle size distribution.

Embodiment 36: The device of any one or more embodiments, further comprising: a controller in communication with a memory and a processor, wherein the controller is communicatively coupled to the device and configured to control at least a portion of the flow and/or distribution of granules.

Embodiment 37: The device of any one or more embodiments, wherein the device is configured to change between at least a first state and a second state, wherein the change in state is associated with a change in the distribution and/or flow of granules.

Embodiment 38: The device of any one or more embodiments, wherein the controller is configured to control a change in state of the device.

Embodiment 39: The device of any one or more embodiments, wherein the change in state of the device occurs while granules are flowing through a distribution opening of the device.

Embodiment 40: The device of any one or more embodiments, further comprising one or more sensors configured to measure one or more granule distribution properties from the group of granule flow, granule density variation, particle size distribution, reclamation source, or any combination thereof.

Embodiment 41: The device of any one or more embodiments, wherein the one or more sensors are situated upstream of the device, such that the granules are measured prior to reaching the device.

Embodiment 42: The device of any one or more embodiments, wherein the one or more sensors include an optical sensor configured to create digital images of at least a portion of the granules from the group of granules, and wherein one or more processors in communication with the sensors analyze the digital images to measure and quantify the one or more granule distribution properties.

Embodiment 43: The device of any one or more embodiments, wherein the measurements are made as granules are moving.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting.

Benefits, other advantages, and solutions to problems have been described above with regard to specific embodiments. However, the benefits, advantages, solutions to problems and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include a range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A building product comprising:
a body including a covered region including granules, wherein at least 18 wt % of the granules comprise reclaimed granules having an average residual asphalt of at least 0.1 wt % for a total weight of the reclaimed granules.

2. The building product of claim 1, wherein at least 20 wt % of the granules comprise reclaimed granules for a total weight of the granules.

3. The building product of claim 1, wherein the reclaimed granules include at least 0.3 wt % residual asphalt on an exterior surface for a total weight of the reclaimed granules.

4. The building product of claim 1, wherein the reclaimed granules include not greater than 90 wt % residual asphalt on an exterior surface for a total weight of the reclaimed granules.

5. The building product of claim 1, further comprising a multilayered roofing product including a first layer and a second layer, wherein at least a portion of the second layer is overlying the first layer and defining the covered region.

6. The building product of claim 5, wherein the covered region includes a headlap region of a roofing shingle.

7. The building product of claim 1, wherein the granules in the covered region have a density variation of at least 0.2 g/cc and not greater than 5 g/cc.

8. The building product of claim 1, wherein the granules further comprise an adhesion of not greater than 0.7 g.

9. The building product of claim 1, wherein the granules further comprise at least one of:
a) a particle having a core and at least a partial coating overlying a surface of the particle;
b) an average density within a range of at least 2.0 g/cc and not greater than 4.0 g/cc;
c) an average particle size (D50) within a range of at least 25 microns to not greater than 4 mm;
d) a solid particulate material;
e) a porous particulate material;
f) an inorganic material including at least one material from the group of oxides, carbides, nitrides, borides, or any combination thereof;
g) a biocidal material;
h) a color variation having L* values between 30-80;
i) or any combination of two or more of any of a)-h).

10. The building product of claim 1, wherein the granules overlie at least 50% of the surface area of the covered region.

11. A building product comprising:
a body including a covered region including granules, wherein at least 1 wt % of the granules comprise reclaimed granules having an average residual asphalt of at least 0.1 wt % for a total weight of the granules and a density variation of at least 0.2 g/cc and not greater than 5 g/cc.

12. The building product of claim 11, wherein at least 5 wt % of the granules comprise reclaimed granules for a total weight of the granules.

13. The building product of claim 11, wherein the reclaimed granules include at least 0.3 wt % residual asphalt on an exterior surface for a total weight of the reclaimed granules.

14. The building product of claim 13, wherein the reclaimed granules include not greater than 90 wt % residual asphalt on an exterior surface for a total weight of the reclaimed granules.

15. The building product of claim 11, further comprising a multilayered roof covering product including a first layer and a second layer, wherein at least a portion of the second layer is overlying the first layer and defining the covered region.

16. The building product of claim 15, wherein the covered portion includes a headlap portion of a roofing shingle.

17. The building product of claim 11, wherein the granules further comprise adhesion granule loss of not greater than 0.7 g.

18. The building product of claim 11, wherein the granules further comprise at least one of:
a) a particle having a core and at least a partial coating overlying a surface of the particle;
b) a density within a range of at least 2.0 g/cc to 4.0 g/cc;
c) a particulate having an average particle size (D50) within a range of at least 25 microns to not greater than 4 mm;
d) a solid particulate material;
e) a porous particulate material;
f) an inorganic material including at least one material from the group of oxides, carbides, nitrides, borides, or any combination thereof;
g) an biocidal material;
h) a color variation of at least L* of 30-80;
i) or any combination of two or more of any of a)-h).

19. A device for controlling the flow and/or distribution of granules for application onto a building product, wherein the device includes adaptive control configured to control the flow and/or distribution of granules, wherein the granules include at least 1 wt % reclaimed granules.

20. The device of claim 19, wherein the adaptive control includes a change in state of the device to control a flow and/or distribution of granules to the building product and/or a change in the size of a distribution opening of the device and wherein the change in state is at least partially based on at least:
a) one or more granule distribution properties from the group of granule flow, granule density variation, particle size distribution, reclamation source, or any combination thereof; and
b) one or more granule characteristics from the group of color, density, average size, shape, composition, asphalt content, particle size distribution.
